(19) United States
(12) Patent Application Publication
(10) Pub. No.: US 2005/0008240 A1
(43) Pub. Date: Jan. 13, 2005

(54) Stitching of video for continuous presence multipoint video conferencing

(76) Inventors: Ashish Banerji, Gaithersburg, MD (US); Kannan Panchapakesan, Germantown, MD (US); Kumar Swaminathan, North Potomac, MD (US)

Correspondence Address: THE DIRECTV GROUP, INC.;RE/R11/A109, P.O. Box 956, El Segundo, CA, 90245-0956, US

(21) Appl. No.: 10/836,672

(22) Filed: Apr. 30, 2004

Related U.S. Application Data
(60) Provisional application No. 60/467,457, filed on May 2, 2003.
(60) Provisional application No. 60/471,002, filed on May 16, 2003.
(60) Provisional application No. 60/508,216, filed on Oct. 2, 2003.

(51) Int. Cl. G06K 9/46; H04N 5/235; H04N 13/02

(52) U.S. Cl. 382/238; 348/222.1; 348/47

(57) ABSTRACT

A drift-free hybrid method of performing video stitching is provided. The method includes decoding a plurality of video bitstreams and storing prediction information. The decoded bitstreams form video images, spatially composed into a combined image. The image comprises frames of ideal stitched video sequence. The method uses prediction information in conjunction with previously generated frames to predict pixel blocks in the next frame. A stitched predicted block in the next frame is subtracted from a corresponding block in a corresponding frame to create a stitched raw residual block. The raw residual block is forward transformed, quantized, entropy encoded and added to the stitched video bitstream along with the prediction information. Also, the stitched raw residual block is inverse transformed and dequantized to create a stitched decoded residual block. The residual block is added to the predicted block to generate the stitched reconstructed block in the next frame of the sequence.

The present application claims benefit under 35 U.S.C. section 119(e) of the following U.S. Provisional Patent Applications, the entireties of which are incorporated herein by reference: (i) Application No. 60/467,457, filed May 2, 2003 (“Combining/Stitching of Standard Video Bitstreams for Continuous Presence Multipoint Videoconferenceing”); (ii) Application No. 60/471,002, filed May 16, 2003 (“Stitching of H.264 Bitstreams for Continuous Presence Multipoint Videoconferenceing”); and (iii) Application No. 60/508,216, filed Oct. 2, 2003 (Stitching of Video for Continuous Presence Multipoint Videoconferenceing”).

### BACKGROUND OF THE INVENTION

The present invention relates to methods for performing video stitching in continuous-presence multipoint video conferences. In multipoint video conferences a plurality of remote conference participants communicate with one another via audio and video data which are transmitted between the participants. The location of each participant is commonly referred to as a video conference end-point. A video image of the participant at each respective end-point is recorded by a video camera and the participant's speech is likewise recorded by a microphone. The video and audio data recorded at each end-point are transmitted to the other end-points participating in the video conference. Thus, the video images of remote conference participants may be displayed on a local video monitor to be viewed by a conference participant at a local video conference end-point. The audio recorded at each of the remote end-points may likewise be reproduced by speakers located at the local end-point. Thus, the participant at the local end-point may see and hear each of the other video conference participants, as may all of the participants. Similarly, each of the participants at the remote end-points may see and hear all of the other participants, including the participant at the arbitrarily designated local end-point.

In a point-to-point video conference the video image of each participant is displayed on the video monitor of the opposite end-point. This is a straight forward proposition since there are only two end-points and the video monitor at each end-point need only display the single image of the other participant. In multipoint video conferences, however, the several video images of the multiple conference participants must somehow be displayed on a single video monitor so that a participant at one location can see and hear the participants at all of the other multiple locations. There are two operating modes that are commonly used to display the multiple participants participating in a multipoint video conference. The first is known as Voice Activation (VA) mode, wherein the image of the participant who is presently speaking (or the participant who is speaking loudest) is displayed on the video monitors of the other end-points. The second is Continuous Presence (CP) mode.

In CP mode multiple images of the multiple remote participants are combined into a single video image and displayed on the video monitor of the local end-point. If there are 5 or fewer participants in the video conference, the 4 (or fewer) remote participants may be displayed simultaneously on a single monitor in a 2×2 array, as shown in FIG. 1. Individual video images 2, 4, 6 and 8 of the remote participants A, B, C and D are combined in a single image 10 that includes all of the four remote participants. Picture 2 of participant A is displayed in a first position in the upper left quadrant of the combined image 10. Picture 4 of participant B is displayed in a second position in the upper right quadrant of the combined image 10. Picture 6 of participant C is displayed in a third position in the lower left quadrant of the combined image 10. And Picture 8 of participant D is displayed in a fourth position in the lower right quadrant of combined image 10. This combined or “stitched” image 10 is displayed on the video monitor of a video conference end-point associated with a fifth participant E (See FIG. 2 as described below). In the case where there are more than 5 participants, one of the four quadrants of the combined image, such as the lower right quadrant where the image of participant D is displayed, may be configured for VA operation so that, although not all of the remote participants can be displayed at the same time, at least the person speaking will always be displayed, along with a number of other conference participants.

FIG. 2 is a schematic representation of a possible multipoint video conference over a satellite communications network. In this example, five video conference end-points 20, 22, 24, 26, and 28 are located at three remote locations 14, 16 and 18. For purposes of this example we will assume that participant E is located at the first site 14 and is associated with end-point 20. Participant A is located at the second site 16 and is associated with end-point 22. Participants B, C, and D are all located at the third site and are associated with end-points 24, 26, and 28, respectively. The remainder of this discussion will focus on preparing a stitched video image 10, of participants A, B, C, and D as shown in FIG. 1, to be displayed at end-point 20 to be viewed by participant E.

Each end-point includes a number of similar components. The components that make up end points 22, 24, 26, and 28 are substantially the same as those of end-point 20 which are now described. End-point 20 includes a video camera 30 for recording a video image of the corresponding participant and a microphone 32 for recording his or her voice. Similarly, end-point 20 includes a video monitor 34 for displaying the images of the other participants and a speaker 36 for reproducing their voices. Finally, end-point 20 includes a video conference appliance 38, which controls 30, 32, 34 and 36, and moreover, is responsible for transmitting the audio and video signals recorded by the video camera 30 and microphone 32 to a multipoint control unit 40 (MCU) and for receiving the combined audio and video data from the remote end-points via the MCU.

There are two ways of deploying a multipoint control unit (MCU) in a multipoint video conference: In a centralized architecture 39 shown in FIG. 3, a single MCU 41 controls a number of participating end-points 43, 45, 47, 49, and 51. FIG. 2, on the other hand, illustrates a decentralized architecture, where each site participating in the video conference 12 has an MCU associated therewith. In a decentralized architecture, multiple end-points may be connected to a single MCU, or an MCU may be associated with a single end-point. Thus, at the first site 14 a single MCU 40 is connected to end-point 20. At the second site 16 a single MCU 42 is also connected to single end-point 22. And at the third site 18, a single MCU 44 is connected to end-points 24, 26 and 28. The MCUs 40, 42 and 44 are responsible for transmitting and receiving audio and video data to and from one another over a network in order to disseminate the video and audio data recorded at each end-point for display and playback on all of the other end-points. In the present example the video conference 12 takes place over a satellite communications network. Therefore, each MCU 40, 42, 44 is connected to a satellite terminal 46, 48, 50 in order to broadcast and receive audio and video signals via satellite 52.

To ensure compatibility of video conferencing equipment produced by diverse manufacturers, audio and video coding standards have been developed. So long as the coded syntax of bitstream output from a video conferencing device complies with a particular standard, other components participating in the video conference will be capable of decoding it regardless of the manufacturer.

At present, there are three video coding standards relevant to the present invention. These are ITU-T H.261, ITU-T H.263 and ITU-T H.264. Each of these standards describes a coded bitstream syntax and an exact process for decoding it. Each of these standards generally employs a block based video coding approach. The basic algorithms combine inter-frame prediction to exploit temporal statistical dependencies and intra-frame prediction to exploit spatial statistical dependencies. Intra-frame or I-coding is based solely on information within the individual frame being encoded. Inter-frame or P-coding relies on information from other frames within the video sequence, usually frames temporally preceding the frame being encoded.

Typically a video sequence will comprise a plurality of I and P coded frames, as shown in FIG. 4. The first frame 54 in the sequences is intra-frame coded since there are no temporally previous frames on which to draw information for P-coding. Subsequent frames may then be inter-frame coded using data from the first frame 54 or other previous frames depending on the position of the frame within the video sequence. Over time, synchronization errors build up between the encoder and decoder when using inter-frame coding due to floating point inverse transform mismatch between encoder and decoder in standards such H.261 and H.263. Therefore the coding sequence must be reset by periodically inserting an intra-frame coded frame. To minimize the deleterious effects of such synchronization errors, both H.261 and H.263 require that a given macroblock (a collection of blocks of pixels)_of pixel data must be intra-coded at least once every 132 times it is encoded. One method to satisfy this intra-frame refresh requirement is shown in FIG. 4, where the first frame 54 is shown as an I-frame and the next several frames 56, 58, 68 are P-frames. Another I-frame 62 is inserted in the sequence followed by another group of several P-frames 64, 66, 68. Though the number I and P-frames may vary, the requirement can be satisfied if the number of consecutive P-frames is not allowed to exceed 132. More precisely, every macroblock is required to be refreshed at least once every 132 frames, but not necessarily simultaneously, by H.261 and H.263 standards. The H.264 standard uses precise integer transform, which does not lead to synchronization errors, and hence H.264 does not have such a periodic intra coding requirement. However, it does require that every video sequence begin with an instantaneous decoder refresh (IDR) frame that resets the decoder memory.

According to each of these standards a video encoder receives input video data as video frames and produces an output bitstream which is compliant with the particular standard. A decoder receives the encoded bitstream and reverses the encoding process to re-generate each video frame in the video sequence. Each video frame includes three different sets of pixels Y, Cb and Cr. The standards deal with YCbCr data in a 4:2:0 format. In other words, the resolution of the Cb and Cr components is ¼ that of the Y component. The resolution of the Y component in video conferencing images is typically defined by one of the following picture formats:
QCIF: 176×144 pixels
CIF: 352×288 pixels
4CIF: 704×576 pixels.
   H.261 Video Coding

According to the H.261 video coding standard, a frame in a video sequence is segmented into pixel blocks, macroblocks and groups of blocks, as shown in FIG. 5. A pixel block 70 is defined as an 8×8 array of pixels. A macroblock 72 is defined as a 2×2 array of Y blocks 72, 1 Cb block and 1 Cr block. For a QCIF picture, a group of blocks (GOB) 74 is formed from three full rows of eleven macroblocks each. Thus, each GOB comprises a total of 176×48 Y pixels and the spatially corresponding sets of 88×24 Cb pixels and Cr pixels.

The syntax of an H.261 bitstream is shown in FIG. 6. The H.261 syntax is hierarchically organized into four layers: a picture layer 75; a GOB layer 76; a macroblock layer 78; and block layer 80. The picture layer 75 includes header information 84 followed by a plurality of GOB data blocks 86, 88, and 90. In an H.261 QCIF picture layer, the header information 84 will be followed by 3 separate GOB data blocks. A CIF picture uses the same spatial dimensions for its GOBs, and hence a CIF picture layer will consist of 12 separate GOB data blocks.

At the GOB layer 76, each GOB data block comprises header information 92 and a plurality of macroblock data blocks 94, 96, and 98. Since each GOB comprises 3 rows of 11 macroblocks each, the GOB layer 76 will include a total of upto 33 macroblock data blocks. This number remains the same regardless of whether the video frame is a CIF or QCIF picture. At the macroblock layer 78, each macroblock data block comprises macroblock header information 100 followed by six pixel block data blocks, 102, 104, 106, 108, 110 and 112, one for the Y component of each of the four Y pixel blocks that form the macroblock, one for the Cb component and one for the Cr component. At the block layer 88, each block data includes transform coefficient data 113 followed by End of the Block marker 114. The transform coefficients are obtained by applying an 8×8 DCT transform on the 8×8 pixel data for intra macroblocks (i.e. macroblocks where no motion compensation is required for decoding) and on the 8×8 residual data for inter macroblocks (i.e. macroblocks where motion compensation is required for decoding). The residual is the difference between the raw pixel data and the predicted data from motion estimation.

H.263 Video Coding

H.263 is similar to H.261 in that it retains a similar block and macroblock structure as well as the same basic coding algorithm. However, the initial version of H.263 included four optional negotiable modes (annexes) which provide better coding efficiency. The four annexes to the original version of the standard were unrestricted motion vector mode; syntax-based arithmetic coding mode; advanced prediction mode; and a PB-frames mode. What is more, version two of the standard included additional optional modes including: continuous presence multipoint mode; forward error correction mode; advanced intro coding mode; deblocking filter mode; slice structured mode; supplemental enhancement information mode; improved PB-frames mode; reference picture mode; reduced resolution update mode; independent segment decoding mode; alternative inter VLC mode; and modified quantization mode. A third most recent version includes an enhanced reference picture selection mode, a data partitioned slice mode; and an additional supplemental enhancement information mode. H.263 supports SQCIF, QCIF, CIF, 4CIF, 16 CIF, and custom picture formats.

Some of the optional modes commonly used in the video conferencing context include: Unrestricted motion vector mode (Annex D), advanced prediction mode (Annex F), advanced intra-coding mode (Annex I), deblocking filter mode (Annex J) and modified quantization mode (Annex T). In the unrestricted motion vector mode, motion vectors are allowed to point outside the picture. This allows for good prediction if there is motion along the boundaries of the picture. Also, longer motion vectors can be used. This is useful for larger picture formats such as 4CIF and 16CWF and for smaller picture formats when there is motion along the picture boundaries. In the advanced prediction mode (Annex F) four motion vectors are allowed per macroblock. This significantly improves the quality of motion prediction. Also, overlapped block motion compensation can be used which reduces blocking artifacts. Next, in the advanced intra coding mode (Annex I) compression for intra macroblocks is improved. Prediction from neighboring intra macroblocks, modified inverse quantization of intra blocks, and from a separate VLC table is used for intra coefficients. In the deblocking filter mode (Annex J), an in-loop filter is applied to the boundaries of the 8×8 blocks. This reduces blocking artifacts leading to poor picture quality and inaccurate prediction. Four motion vectors are allowed per macroblock. This significantly improves the quality of motion prediction. Motion vectors are allowed to point outside the picture. This allows for good prediction if there is motion along the boundaries of the picture. Finally in the modified quantization mode (Annex T), arbitrary quantizer selection is allowed at the macroblock level which allows for a more precise rate control.

The syntax of an H.263 bitstream is illustrated in FIG. 7. As with the H.261 bitstream syntax, the H.263 bitstream is hierarchically organized into a picture layer 116, a GOB layer 118, a macroblock layer 120 and a block layer 122. The picture layer 116 includes header information 124 and GOB data blocks 126, 128 and 130. The GOB layer 118, in turn, includes header information 132 and macroblock layer blocks 134, 136, 138. The macroblock layer 120 includes header information 142, and pixel block data blocks 144, 146, 148, and the block layer 122 includes transform coefficient data blocks 150, 152.

A significant difference between H.261 and H.263 video coding is the GOB structure. In H.261 coding, each GOB is 3 successive rows of 11 consecutive macroblocks, regardless of the image type (QCIF, CIF, 4CIF, etc.). In H.263, however, a QCIF GOB is a single row of 11 macroblocks, whereas a CIF GOB is a single row of 22 macroblocks. Other resolutions have yet different GOB definitions. This leads to complications when stitching H.263 encoded pictures in the compressed domain as will be described in more detail with regard to existing video stitching methods.

H.264 Coding

H.264 is the most recently developed video coding standard. Unlike H.261 and H.263 coding, H.264 has a more flexible block and macroblock structure, and introduces the concept of slices and slice groups. According to H.264, a pixel block may be defined as one of a 4×4, 8×8, 16×8, 8×16 or 16×16 array of pixels. Like in H.261 and H.263, a macroblock comprises a 16×16 array of Y pixels and corresponding 8×8 arrays of Cb and Cr pixels. In addition, a macroblock partition is defined as a block of luma samples and two corresponding blocks of chroma samples resulting from a partitioning of a macroblock; a macroblock partition is used as a basic unit for inter prediction. A slice group is defined as a subset of macroblocks that is a partitioning of the frame, and a slice is defined as an integer number of consecutive macroblocks in raster scan order within a slice group.

Macroblocks are distinguished based on how they are coded. In the Baseline profile of H.264, macroblocks which are coded using motion prediction based on information from other frames are referred to as inter- or P-macroblocks (In the Main and Extended profiles, there is also a B-macroblock; only Baseline profile is of interest in the context of video conference applications). Macroblocks which are coded using only information from within the same slice are referred to as intra- or I-macroblocks. An I-slice contains only I macroblocks, which are coded using only information from within the same frame are referred to as intra- or I-macroblocks. An I-slice contains only I-macroblocks, while a P-slice may contain both I and P macroblocks. An H.264 video sequence 154 is shown in FIG. 8. The video sequence begins with an instantaneous decoder refresh frame (IDR) frame 156. An IDR frame is composed entirely of I-slices which include only intra-coded macroblocks. In addition, the IDR frame has the effect of resetting the decoder memory. Frames following an IDR frame cannot use information from frames preceding the IDR frame for prediction purposes. The IDR frame is followed by a plurality of non-IDR frames 158, 160, 162, 164, 166. Non-IDR frames may only include I and P slices for video conference applications. The video sequence 154 ends on the last non-IDR frame, e.g., 166 preceding the next (if any) IDR frame.

A network abstraction layer unit stream 168 for a video sequence encoded according to H.264 is shown in FIG. 9. The H.264 coded NAL unit stream includes a sequence parameter set (SPS) 170 which contains the properties that are common to the entire video sequence. The next level 172 holds the picture parameters sets (PPS) 174, 176, 178. The PPS units include the properties common to the entire picture. Finally, the slice layer 180 holds the header (properties common to the entire slice) and data for the individual slices 182, 184, 186, 188, 190, 192, 194, 196 that make up the various frames.

Approaches to Video Stitching

Referring back to FIGS. 1 and 2, in order to simultaneously display the combined images of remote participants A, B, C and D on the video monitor 34 associated with end-point 20, the four individual video data bitstreams from end-points 22, 24, 26, and 28 must be combined or “stitched” together into a single bitstream at MCU 40. At present, there are two general approaches to performing video stitching, the Pixel Domain approach and the Compressed Domain approach. This invention provides a third, hybrid approach which will be described in detail in the detailed description of the invention portion of this specification. As a typical example, the description of stitching approaches in this invention assumes the incoming video resolution to be QCIF and the outgoing stitched video resolution to be CIF. This is, however, easily generalizable e.g. incoming and outgoing video resolutions can be CIF and 4CIF respectively.

Conceptually, the pixel domain is straightforward and may be implemented irrespective of the coding standard used. The pixel domain approach is illustrated in FIG. 10. Four coded QCIF video bitstreams 185, 186, 187 and 188 representing the pictures 2, 4, 6, and 8 in FIG. 1 are received from end-points 22, 24, 26, and 28 by MCU 40 in FIG. 2. Within MCU 40 each QCIF bitstream is separately decoded by decoders 189 to provide four separate QCIF pictures 190, 191, 192, 193. The four QCIF images are then input to a pixel domain stitcher 194. The pixel domain stitcher 194 spatially composes the four QCIF pictures into a single CIF image comprising a 2×2 array of the four decoded CIF images. The combined CIF image is referred to as an ideal stitched picture because it represents the best quality stitched image obtainable after decoding the QCIF images. The ideal stitched picture 195 is then re-encoded by an appropriate encoder 196 to produce a stitched CIF bitstream 197. The CIF bitstream may then be transmitted to a video conference appliance where it is decoded by decoder 198 and displayed on a video monitor.

Although easy to understand, a pixel domain approach is computationally complex and memory intensive. Encoding video data is a much more complex process than decoding video data, regardless of the video standard employed. Thus, the step of re-encoding the combined video image after spatially composing the CIF image in the pixel domain greatly increases the processing requirements and cost of the MCU 40. Therefore, pixel domain video stitching is not a practical solution for low-cost video conferencing systems. Nonetheless, useful concepts can be derived from an understanding of pixel domain video stitching. Since the ideal stitched picture represents the best quality image possible after decoding the four individual QCIF data streams, it can be used as an objective benchmark for determining the efficacy of different methods for performing video stitching. Any subsequent coding of the ideal stitched picture will result in some degree of data loss and a corresponding degradation of image quality. The amount of data loss between the ideal stitched picture and a subsequently encoded and decoded image serves as a convenient point of comparison between various stitching methods.

Because of the processing delays and added complexities of re-encoding the ideal stitched video sequence inherent to the pixel domain approach, a more resource efficient approach to video stitching is desirable. Hence, a compressed domain approach is desirable. Using this approach, video stitching is performed by directly manipulating the incoming QCIF bitstreams while employing a minimal amount of decoding and re-encoding. For reasons that will be explained below, pure compressed domain video stitching is possible only with H.261 video coding.

As has been described above with regard to the bitstream syntax of the various coding standards, a coded video bitstream contains two types of data: (i) headers—which carry key global information such as coding parameters and indexes; and (ii) the actual coded image data themselves. The decoding and re-encoding present in the compressed domain approach involves decoding and modifying changes some of the key headers in the video bitstream but not decoding the coded image data themselves. Thus, the computational and memory requirements of the compressed domain approach are a fraction of those of the pixel domain approach.

The compressed domain approach is illustrated in FIG. 11. Again, the incoming QCIF bitstreams 185, 186, 187, 188 represent pictures 2, 4, 6, and 8 of participants A, B, C, and D. Rather than decoding the incoming QCIF bitstreams, the images are stitched directly in the compressed domain stitcher 199. The bitstream 200 output from the compressed domain stitcher 199 need not be re-encoded since the incoming QCIF data were never decoded in the first place. The output bitstream may be decoded by a decoder 201 at the end-point appliance that receives the stitched bitstream 200.

FIG. 12 shows the GOB structure of the four incoming H.261 QCIF bitstreams 236, 238, 240, and 242 representing pictures A, B, C, and D respectively (see FIG. 1). FIG. 12 also shows the GOB structure of an H.261 CIF image 244 which includes the stitched images A, B, C and D. Each QCIF image 236, 238, 240 and 242 includes three GOBs having GOB index numbers (1), (3) and (5). The CIF image 244 includes twelve GOBs having GOB index numbers (1)-(12) and arranged as shown. In order to combine the four QCIF images 236, 238, 240, 242 into the single CIF image 244, GOBs (1), (3), (5) from each QCIF image must be mapped into an appropriate GOB (1)-(12) in the CIF image 244. Thus, GOBs (1), (3), (5) of QCIF Picture A 236 are respectively mapped into GOBs (1), (3), (5) of CIF image 244. These GOBs occupy the upper left quadrant of the CIF image 244 where it is desired to display Picture A. Similarly, GOBs (1), (3), (5) of QCIF Picture B 238 are respectively mapped to CIF image 244 GOBs (2), (4), (6). These GOBs occupy the upper right quadrant of the CIF image where it is desired to display Picture B. GOBs (1), (3), (5) of QCIF Picture C 240 are respectively mapped to GOBs (7), (9), (11) of the CIF image 244. These GOBs occupy the lower left quadrant of the CIF image where it is desired to display Picture C. Finally, GOBs (1), (3), (5) of QCIF Picture D 242 are respectively mapped to GOBs (8), (10), (12) of CIF image 244 which occupy the lower right quadrant of the image where it is desired to display Picture D.

To accomplish the mapping of the QCEF GOBs from pictures A, B, C, and D into the stitched CIF image 244, the header information in the QCIF images 236, 238, 240, 242 must be altered as follows. First, since the four individual QCIF images are to be combined into a single image, the picture header information 84 (see FIG. 6) of pictures B, C, and D is discarded. Further, the picture header information of Picture A 236 is changed to indicate that the picture data that follows are a single CIF image rather than a QCIF image. This is accomplished via appropriate modification of the six bit PTYPE field. Bit 4 of the 6 bit PTYPE field is set to 1, the single bit PEI field is set to 0, and the PSPARE field is discarded. Next, the index number of each QCIF GOB (given by GN inside 92, see FIG. 6) is changed to reflect the GOB's new position in the CIF image. The index numbers are changed according to the GOB mapping shown in FIG. 12. Finally, the re-indexed GOBs are placed into the stitched bitstream in the order of their new indices.

It should be noted that in using the compressed domain approach only the GOB header and picture header information need to be re-encoded. This provides a significant reduction in the amount of processing necessary to perform the stitching operation as compared to stitching in the pixel domain. Unfortunately, true compressed domain video stitching is only possible for H.261 video coding.

With H.263 stitching the GOB sizes are different between QCIF images and CIF images. As can be seen in FIG. 13, an H.263 QCIF image 246 comprises nine GOBs, eleven macroblocks (176 pixels) wide. The H.263 CIF image 248 on the other hand includes 18 GOBs that are twenty-two macroblocks, 352 pixels wide. Thus, the H.263 QCIF GOBs cannot be mapped into the H.263 GOBs in a natural, convenient way as with H.261 GOBs. Some simple and elegant mechanisms have been developed for altering the GOB headers and rearranging the macroblock data within the various QCIF images to implement H.263 video stitching in the compressed domain. However, these techniques are not without problems due to the following reasons. H.263 coding employes spatial prediction to code the motion vectors that are generated out of the motion estimation process while encoding an image. Therefore, the motion vectors generated by the encoders of the QCIF images will not match those derived by the decoder of the stitched CIF bitstream. These errors will originate near the intersection of the QCIF quadrants, but may propagate through the remainder of the GOB, since H.263 also relies on spatial prediction to code and decode pixel blocks based on surrounding blocks of pixels. Thus, this can have a degrading effect on the quality of the entire CIF image. Furthermore, these mismatch errors will propagate from frame to frame due to the temporal prediction employed by H.263 through inter or P coding. Similar problems arise with the macroblock quantization parameters from the QCIF images as well. To compensate for this, existing methods provide mechanisms for requantizing and re-encoding the macroblocks at or near the quadrant intersections and similar solutions. However, this tends to increase the processing requirements for performing video stitching, and does not completely eliminate the drift.

Similar complications arise when performing compressed domain stitching on H.264 coded images. In H.264 video sequences the presence of new image data in adjacent quadrants changes the intra or inter predictor of a given block/macroblock in several ways with respect to the ideal stitched video sequence. For example, since H.264 allows motion vectors to point outside a picture's boundaries, a QCIF motion vector may point into another QCIF picture in the stitched image. Again, this can cause unacceptable noise at or near the image boundaries that can propagate through the frame. Additional complications may also arise which make compressed domain video stitching impractical for H.264 video coding.

Additonal problems arise when implementing video stitching on real world applications. The MCU (or MCUs) controlling a video conference negotiate with the various endpoints involved in the conference in order to establish various parameters that will govern the conference. For example, such mode negotiations will determine the audio and video codecs that will be used during the conference. The MCU(s) also determine the nominal frame rates that will be employed to send video sequences from the end points to video stitcher in the MCU(s). Nonetheless, the actual frame rates of the various video sequences received from the endpoints may vary significantly from the nominal frame rate. Furthermore, the packetization process of the transmission network over which the video streams are transmitted may cause video frames to arrive at the video stitcher in erratic bursts. This can cause significant problems for the video sticher which, under ideal conditions would assemble stitched video frames in one-to-one synchrony with the frames comprising the individual video sequence received from the endpoints.

Another real world problem for performing video stitching in continous presence multipoint video conferences is the problem of compensating for data that may have been lost during transmission. The severity of data loss may range from lost individual pixel blocksthrough the loss of entire video frames. The video stitcher must be capable of detecting such data loss and compensating for the lost data in a manner that has as negligible an impact on the quality of the stitched video sequence as possible.

Finally, some of the annexes to ITU-T H.263 afford the opportunity to perform video stitching in a manner that is almost entirely within the compressed. Also, video data that is transmitted over IP networks afford other possibilities for performing video stitching in a simple and less expensive way.

Improved methods for performing video stitching are needed. Ideally such methods should be capable of being employed regardless of the video codec being used. Such methods are desired to have low processing requirements. Further, improved methods of video stitching should be capable of drift free stitching so that encoder-decoder mismatch errors are not propagated throughout the image and from one frame to another within the video sequence. Improved video stitching methods must also be capable of compensating for and concealing lost data, including lost pixel blocks, lost macroblocks and even entire lost video frames, finally, improved video stitching methods must be sufficiently robust to handle input video streams having diverse and variable frame rates, and be capable of dealing with video streams that enter and drop out of video conferences at different times.

### SUMMARY OF THE INVENTION

The present invention relates to a drift-free hybrid approach to video stitching. The hybrid approach represents a compromise between the excessive processing requirements of a purely pixel domain approach and the difficulties of adapting the compressed domain approach to H.263 and H.264 encoded bitstreams.

According to the drift-free hybrid approach, incoming video bitstreams are decoded to produce pixel domain video images. The decoded images are spatially composed in the pixel domain to form an ideal stitched video sequence including the images from multiple incoming video bitstreams. Rather than re-encoding the stitched pixel domain ideal stitched image as done in pixel domain stitching, the prediction information from the individual incoming bitstreams is retained. Such prediction information is encoded into the incoming bitstreams when the individual video images are first encoded prior to being received by the video stitcher. While decoding the incoming video bitstreams, this prediction information is regenerated. The video stitcher then creates a stitched predictor for the various pixel blocks in a next frame of a stitched video sequence depending on whether the corresponding macroblocks were intra-coded or inter-coded. For an intra-coded macroblock, the stitched predictor is calculated by applying the retained intra prediction information on the blocks in its causal neighborhood (The causal neighborhood is already decoded before the current block). For an inter-coded macroblock, the stitched predictor is calculated from a previously constructed reference frame of the stitched video sequence. The retained prediction information from the individual decoded video bitstreams is applied to the various pixel blocks in the reference frame to generate the expected blocks in the next frame of the stitched video sequence.

The stitched predictor may differ from a corresponding pixel block in the corresponding frame of the ideal stitched video sequence. These differences can arise due to possible differences between the reference frame of the stitched video sequence and the corresponding frames of the individual video bitstreams that were decoded and spatially composed to create the ideal stitched video sequence. Therefore, a stitched raw residual block is formed by subtracting the stitched predictor for a corresponding pixel block in the corresponding frame of the ideal stitched video sequence. The stitched raw residual block is forward transformed, quantized and entropy encoded before being added to the coded stitched video bitstream.

The drift-free hybrid stitcher then acts essentially as a decoder, inverse transforming and dequantizing the forward transformed and quantized stitched raw residual block to form a stitched decoded residual block. The stitched decoded residual block is added to the stitched predictor to create the stitched reconstructed block. Because the drift-free hybrid stitcher performs substantially the same steps on the forward transformed and quantized stitched raw residual block as are performed by a decoder, the stitcher and decoder remain synchronized and drift errors are prevented from propagating.

The drift-free hybrid approach includes a number of additional steps over a pure compressed domain approach, but they are limited to decoding the incoming bitstreams; forming the stitched predictor; forming the stitched raw residual, forward and inverse transform and quantization, and entropy encoding. Nonetheless these additional steps are far less complex than the process of completely re-encoding the ideal stitched video sequence. The main computational bottlenecks such as motion estimation, intra prediction estimation, prediction mode estimation, and rate control are all avoided by re-using the parameters that were estimated by the encoders that produced the original incoming video bitstreams.

Detailed steps for implementing drift-free stitching is provided for H.263 and H.264 bitstreams. In error-prone environments, it is pointed out that the responsibility of error concealment lies at the decoder part of the overall stitcher, and hence error-concealment procedures are provided as part of a complete stitching solution for H.263 and H.264. In addition, alternative (not-necessarily drift-free) stitching solutions are provided for H.263 bitstreams. Additional features and advantages of the present invention are described in, and will be apparent from, the following Detailed Description of the Invention and the figures.

### BRIEF DESCRIPTION OF THE FIGURES

FIG. 1 shows a typical multipoint video conference video stitching operation in continuous presence mode;

FIG. 2 shows a typical video conference set-up that uses a satellite communications network;

FIG. 3 shows an MCU in a centralized architecture for a continuous presence multipoint video conference;

FIG. 4 shows a sequence of intra- and inter-coded video images/frames/pictures;

FIG. 5 shows a block, a macroblock and a group of blocks structure of an H.261 picture or frame;

FIG. 6 shows the bitstream syntax of an H.261 picture or frame;

FIG. 7 shows the bitstream syntax of an H.263 picture or frame;

FIG. 8 shows an H.264 video sequence;

FIG. 9 shows an H.264-coded network abstraction layer (NAL) unit stream;

FIG. 10 shows a block diagram of the pixel domain approach to video stitching;

FIG. 11 shows a block diagram of the compressed domain approach to video stitching;

FIG. 12 shows the GOB structure for H.261 QCIF and CIF images;

FIG. 13 shows the GOB structure for H.263 QCIF and CIF images;

FIG. 14 shows a flow chart of the drift-free hybrid approach to video stitching of the present invention;

FIG. 15 shows an ideal stitched video sequence stitched in the pixel domain;

FIG. 16 shows an actual stitched video sequence using the drift-free approach of the present invention;

FIG. 17 shows a block diagram of the drift-free hybrid approach to video stitching of the present invention;

FIG. 18 shows stitching of synchronous H.264 bitstreams;

FIG. 19 shows stitching of asynchronous H.264 bitstreams;

FIG. 20 shows stitching of H.264 packet streams in a general scenario;

FIG. 21 shows a mapping of frame_num from an incoming bitstream to the stitched bitstream;

FIG. 22 shows a mapping of reference picture index from an incoming bitstream to the stitched bitstream;

FIG. 23 shows the block numbering for 4×4 luma blocks in a macroblock;

FIG. 24 shows the neighboring 4×4 luma blocks for estimating motion information of a lost macroblock;

FIG. 25 shows the neighbours for motion vector prediction in H.263;

FIG. 26 shows an example of quantizer modification for a nearly compressed domain approach for H.263 stitching; and,

FIG. 27 shows the structure of H.263 payload header in an RTP packet.

### DETAILED DESCRIPTION OF THE INVENTION

The present invention relates to a improved methods for performing video stitching in multipoint video conferencing systems. The method includes a hybrid approach to video stitching that combines the benefits of pixel domain stitching with those of the compressed domain approach. The result is an effective inexpensive method for providing video stitching in multi-point video conferences. Additional methods include a lossless method for H.263 video stitching using annex K; a nearly compressed domain approach for H.263 video stitching without any of its optional annexes; and an alternative practical approach to the H.263 stitching using payload header information in RTP packets over IP networks.

I. Hybrid Approach to Video Stitching

The drift-free hybrid approach provides a compromise between the excessive amounts of processing required to re-encode an ideal stitched video sequence assembled in the pixel domain, and the synchronization drift errors that may accumulate in the decoded stitched video sequence when using coding methods that incorporate motion vectors and other predictive techniques when performing video stitching in the compressed domain. Specific implementations of the present invention will vary according to the coding standard employed. However, the general drift-free hybrid approach may be applied to video conferencing systems employing any of the H.261, H.263 or H.264 and other video coders.

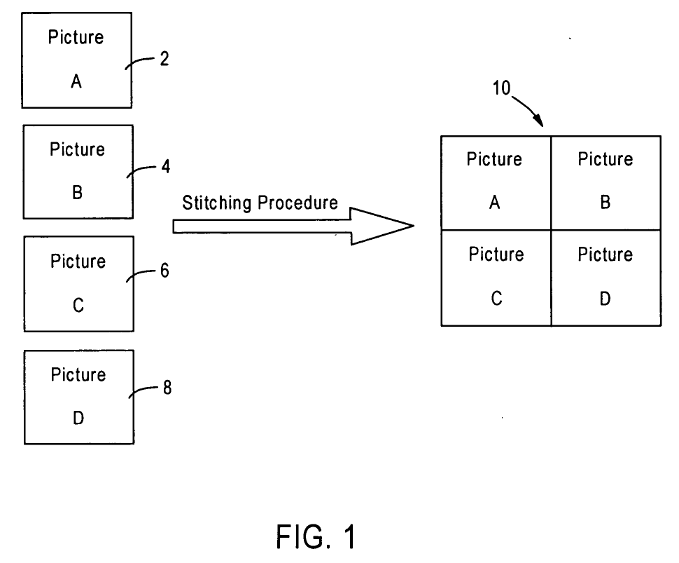

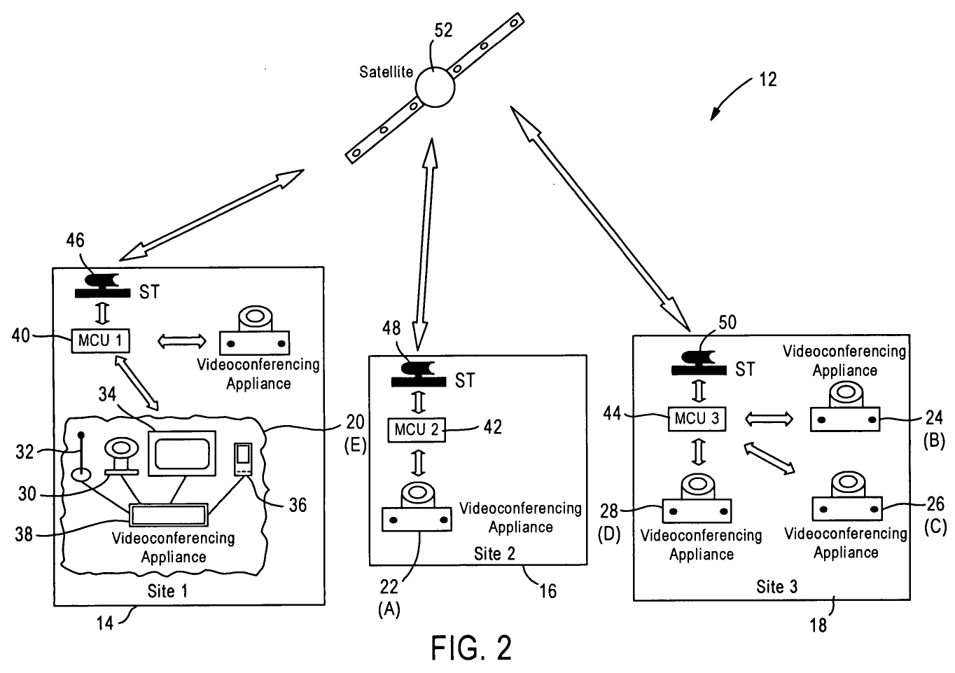

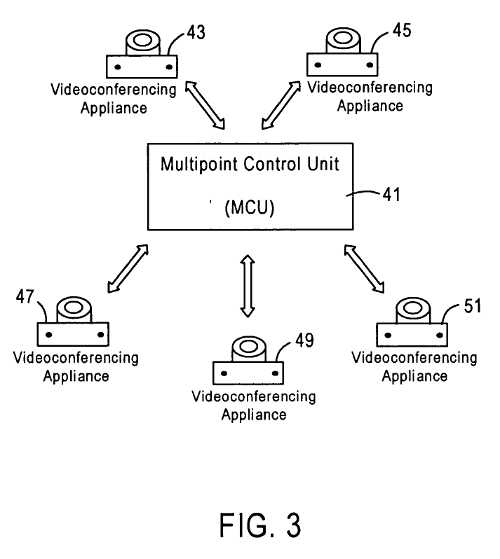

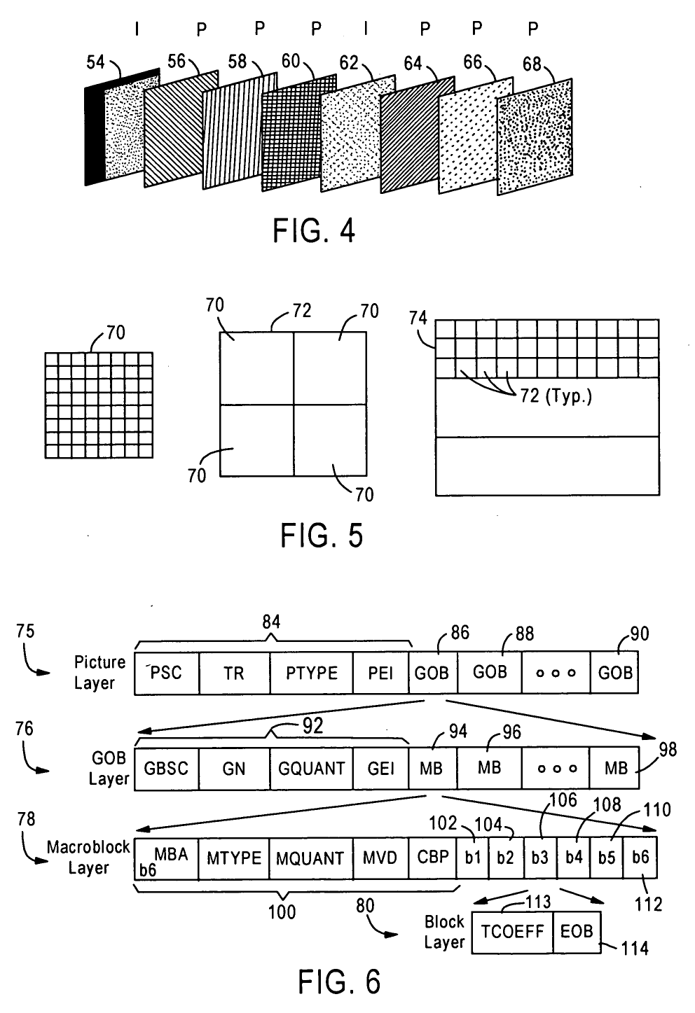

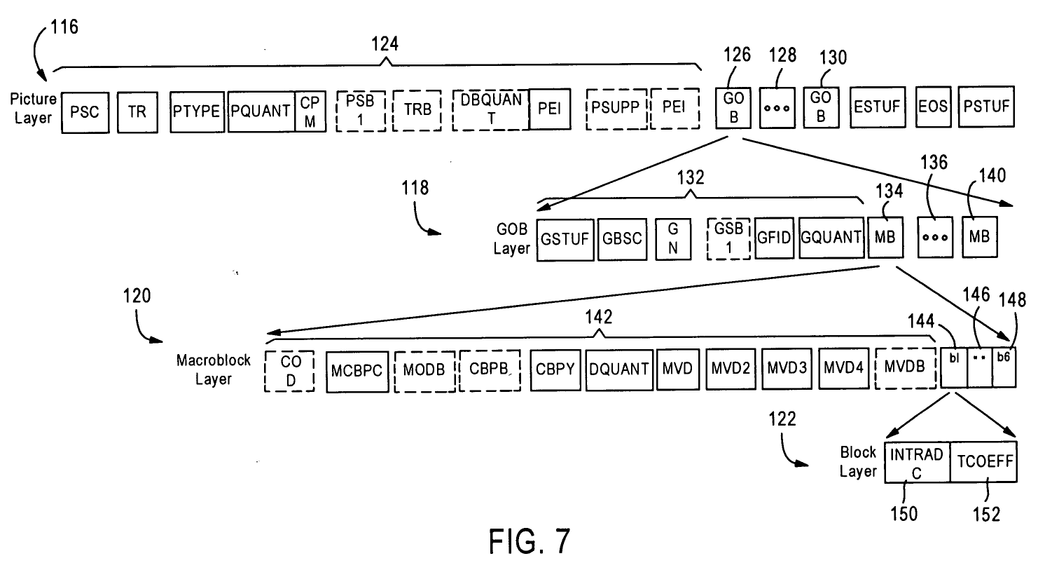

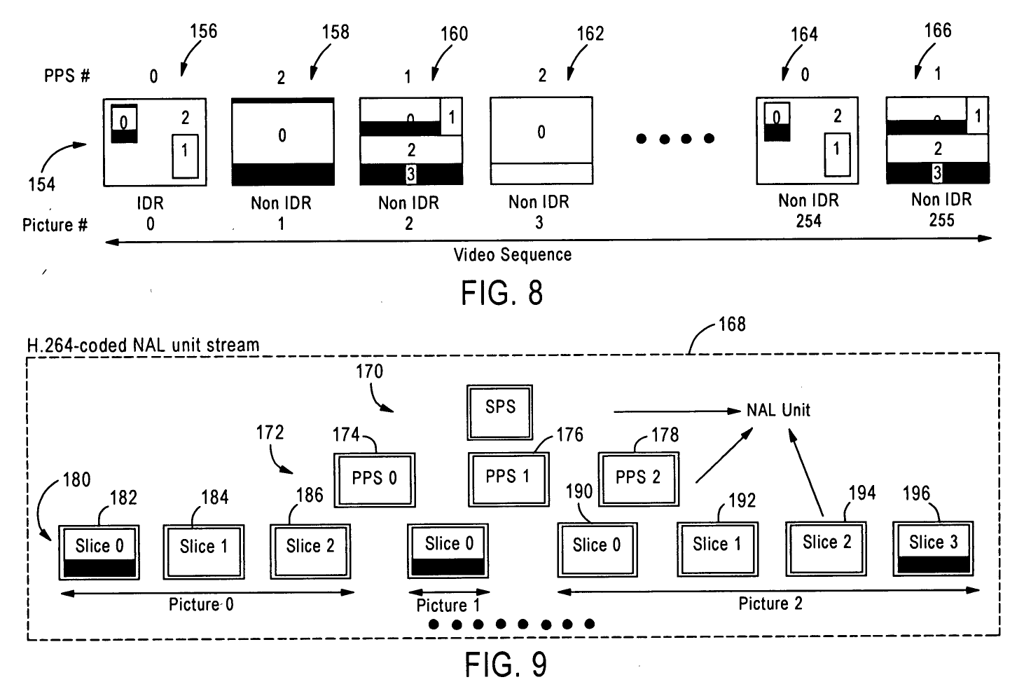

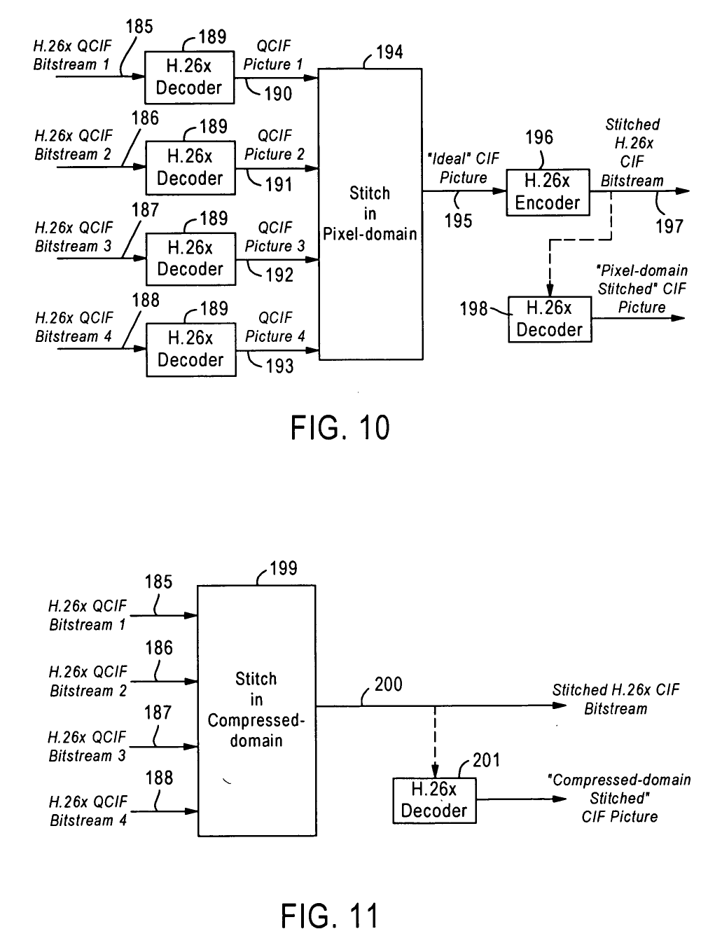

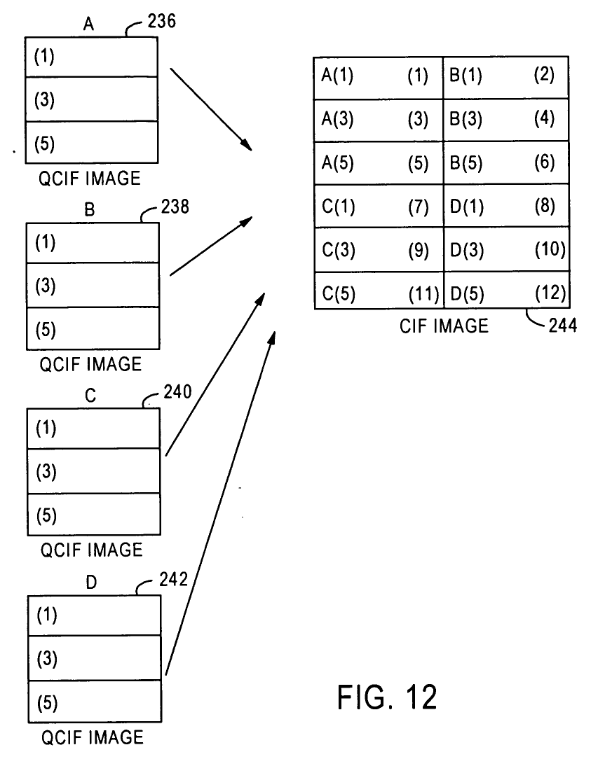

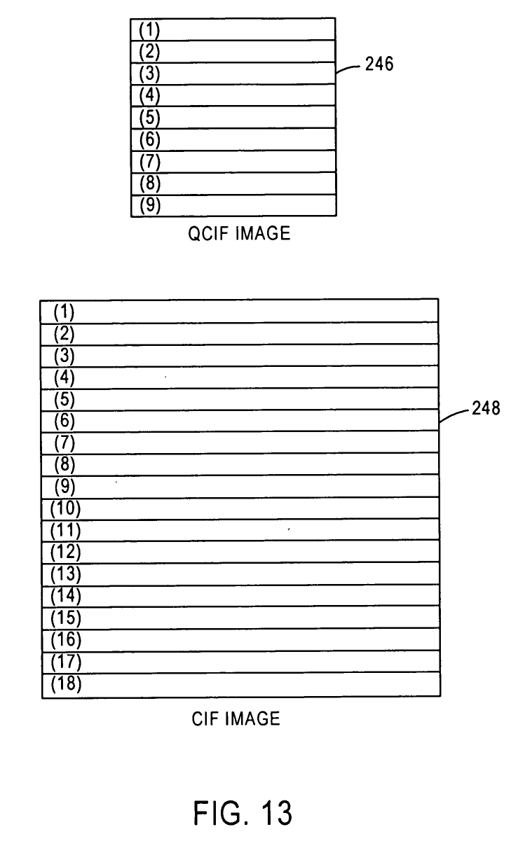

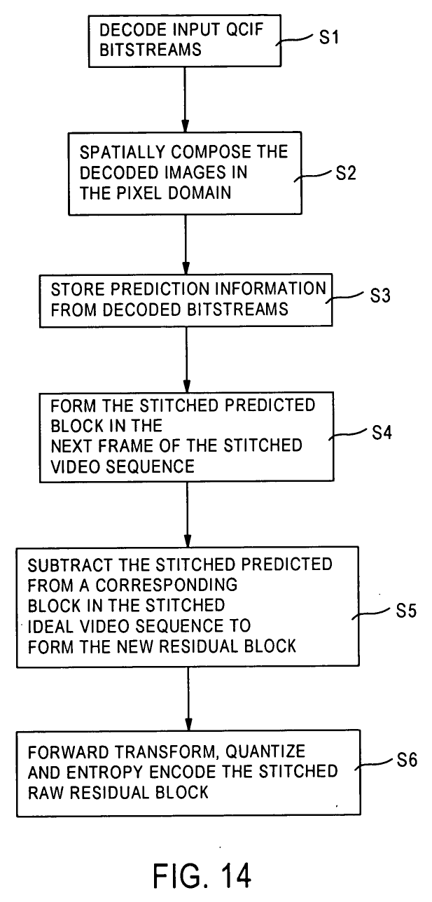

The general drift-free hybrid approach to video stitching will be described with reference to FIGS. 14, 15, 16, and 17. Detailed descriptions of the approach as applied to H.264 and H.263 video coding standards will follow. As was mentioned in the background of the invention, decoding a video sequence is a much less onerous task and requires much less processing resources than encoding a video sequence. The present hybrid approach takes advantage of this fact by decoding the incoming QCIF bitstreams representing pictures A, B, C and D (See FIG. 1) and composing an ideal stitched video sequence comprising the four stitched images in the pixel domain. Rather than re-encoding the entire ideal stitched video sequence, the hybrid approach reuses much of the important coded information such as motion vectors, motion modes and intra prediction modes, from the incoming encoded QCIF bitstreams to obtain the predicted pixel blocks from previously stitched frames, and subsequently encodes the differences between the pixel blocks in the ideal stitched video sequence and the corresponding predicted pixel blocks to form raw residual pixel blocks which are transformed, quantized and encoded into the stitched bitstream.

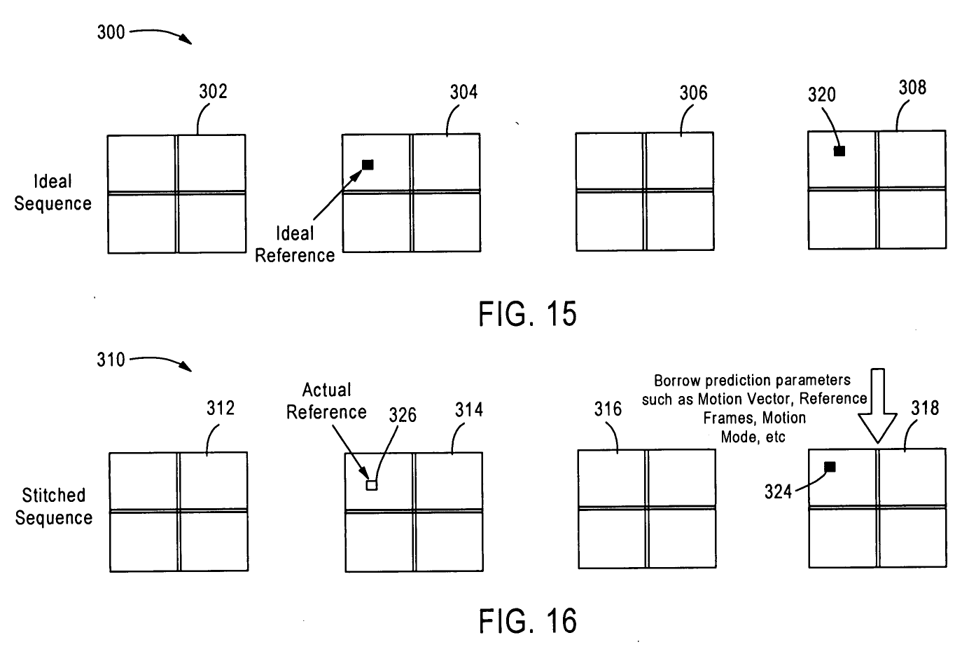

FIG. 15 shows an ideal stitched video sequence 300. The ideal stitched video sequence 300 is formed by decoding the four input QCIF bitstreams representing pictures A, B, C, and D and spatially composing the four images in the pixel domain into the desired 2×2 image array. The illustrated portion of the ideal stitched video sequence includes four frames: a current frame n 306, a next frame (n+1) 308 and two previous frame (n−1) 304 and (n−2) 302.

FIG. 16 shows a stitched video sequence 310 produced according to the hybrid approach of the present invention. The stitched video sequence 310 also shows a current frame n 316, a next frame (n+1) 318, and previous frames (n−1) 314 and (n−2) 312 which correspond to the frames n, (n+1), (n−1) and (n−2) of the ideal stitched video sequence, 306, 308, 304, and 302 respectively.

The method for creating the stitched video sequence is summarized in the flow chart shown in FIG. 14. The method is described with regard to generating the next frame, (n+1) 318 in the stitched video sequence 310. The first step SI is to decode the four input QCWF bitstreams. The next step S2 is to spatially compose the four decoded images into the (n+1)th frame 308 of the ideal stitched video sequence 300. This is the same process that has been described for performing video stitching in the pixel domain. However, unlike the pixel domain approach, the prediction information from the coded QCIF image is retained, and stored in step S3 for future use in generating the stitched video sequence. Next, in step S4, a stitched predictor is formed for each macroblock using the previously constructed frames of the stitched video sequence and the corresponding stored prediction information for each block. In step S5 a stitched raw residual is formed by subtracting the stitched predictor for the block from the corresponding block of the (n+1)th frame of the ideal stitched video sequence. Finally, step S6 calls for forward transforming and quantizing the stitched raw residual and entropy encoding the transform coefficients using the retained quantization parameters. This generates the bits that form the outgoing stitched bitstream.

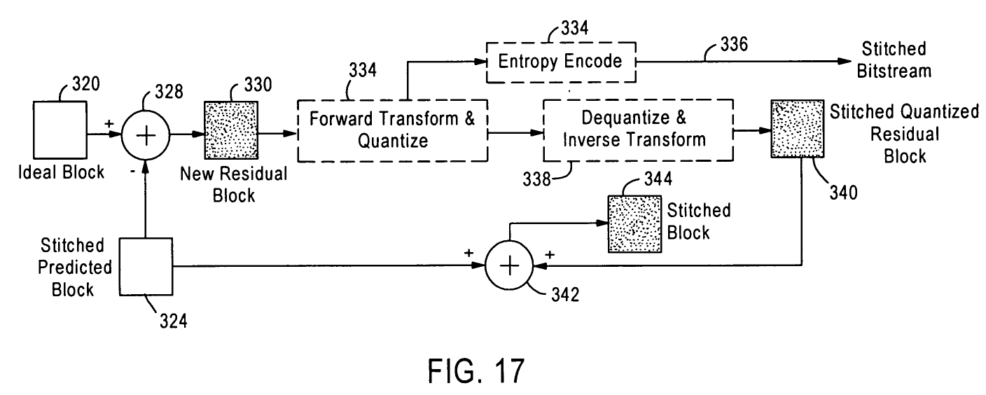

This process is shown in more detail in the block diagram of FIG. 16. Assume that the current frame n 316 of the stitched video sequence has already been generated (as well as previous frames (n−1) 314, (n−2) 312). Information from one or more of these frames is used to generate the next frame of the stitched video sequence (n+1)318. In this case the previous frame (n−1) 304 is used as the reference frame for generating the stitched predictor. Starting with an ideal stitched block 320 from the (n+1)th frame 308 of the ideal stitched video sequence 300, the video stitcher must generate the corresponding block 324 in the (n+1)th frame of the stitched video sequence 310. The ideal stitched block 320 is obtained after the incoming QCIF bitstreams have been decoded and the corresponding images have been spatially composed in the (n+1)th frame 308 of the ideal stitched video sequence 300. The prediction parameters and quantization parameters are stored, as are the prediction parameters and quantization parameters of the corresponding block in the previous reference frame (n−1) 304. The corresponding block 324 in the (n+1)th frame of the stitched video sequence 310 is predicted from block 326 in an earlier reference frame 314 as per the stored prediction information from the decoded QCIF images. The stitched predicted block 324 will, in general, differ from the predicted block obtained as part of the decoding process used for obtaining the corresponding ideal stitched block 320 (while decoding the incoming QCIF streams). As will be described below, the reference frame in the stitched video sequence is separated after a degree of coding and decoding of the block data has taken place. Accordingly, there will be some degree of degradation of the image quality between the ideal stitched reference frame (n−1) 304 and the actual stitched reference frame (n−1) 314. Since the reference frame (n−1) 314 of the stitched sequence already differs from the ideal stitched video sequence, blocks in the next frame (n+1) 318 predicted from the reference frame (n−1) 314 will likewise differ from those in the corresponding next frame (n+1) 308 of the ideal stitched video sequence. The difference between the ideal stitched block 320 and the stitched predicted block is calculated by subtracting the stitched predicted block 324 from the ideal stitched block 320 at the summing junction 328 (see FIG. 17). Subtracting the stitched predicted block 324 from the ideal stitched block 320 produces the stitched raw residual block” 330. The stitched raw residual block 330 is then forward transformed and quantized in the forward transform and quantize block 332. The forward transformed and quantized stitched raw residual block is then entropy encoded at block 334. The output from the entropy encoder 334 is then appended to the stitched bitstream 336.

In a typical video conference arrangement the stitched video bitstream 336 is transmitted from an MCU to one or more video conference appliances at various video conference end-points. The video conference appliance at the end-point decodes the stitched bitstream and displays the stitched video sequence on the video monitor associated with the end-point. According to the present invention, in addition to transmitting the stitched video bitstream to the various end-point appliances, the MCU retains the output data from the forward transform and quantization block 332. The MCU then performs substantially the same steps as those performed by the decoders in the various video conference end-point appliances to decode the stitched raw residual block and generate the stitched predicted block 324 for frame (n+1) 318 of the stitched video sequence. The MCU constructs and retains the next frame in the stitched video sequence so that it may be used as a reference frame for predicting blocks in one or more succeeding frames in the stitched video sequence. In order to construct the next frame 318 of the stitched video sequence, the MCU de-quantizes and inverse transforms the forward transformed and quantized stitched raw residual block in block 338. The output of the de-quantizer and inverse transform block 338 generates the stitched decoded residual block 340. The stitched decoded residual block 340 generated by the MCU will be substantially identical to that produced by the decoder at the end-point appliance. The MCU and the decoder having the stitched predicted block 324, construct the stitched reconstructed block 344 by adding the stitched decoded residual block 340 to the stitched predicted block at summing junction 342. Recall that the stitched raw residual block 330 was formed by subtracting the stitched predicted block 324 from the ideal stitched block 320. Thus, adding the stitched decoded residual block 340 to the stitched predicted block 324 produces a stitched reconstructed block 344 that is very nearly the same as the ideal stitched block 320. The only differences between the stitched reconstructed block 344 and the ideal stitched block 320 result from the data loss in quantizing and dequantizing the data comprising the stitched raw residual block 330. The same process takes place at the decoders.

It should be noted that in generating the stitched predicted block 324, the MCU and the decoder are operating on identical data that are available to both. The stitched sequence reference frame 314 is generated in the same manner at both the MCU and the decoder. Furthermore, the forward transformed and quantized residual block is inverse transformed and de-quantized to produce the stitched decoded residual block 340 in the same manner at the MCU and the decoder. Thus, the stitched decoded residual block 340 generated at the MCU is also identical to that produced by the end-point decoder. Accordingly, the stitched reconstructed block 344 of frame (n+1) of the stitched video sequence 310 resulting from the addition of the stitched predicted block 324 and the stitched decoded residual block 340 will be identical at both the MCU and the end-point appliance decoder. Differences will exist between the ideal stitched block 320 and the stitched reconstructed block 344 due to the loss of data in the quantization process. However, these differences will not accumulate from frame to frame because the MCU and the decoder remain synchronized, operating on the same data sets from frame to frame.

Compared to a pure compressed domain approach, the drift-free hybrid approach of the present invention requires the additional steps of decoding the incoming QCIF bitstreams; generating the stitched prediction block; generating the stitched raw residual block; forward transforming and quantizing the stitched raw residual block; entropy encoding the result of forward transforming and quantized stitched raw residual block; and inverse transforming and de-quantizing this result. However, these additional steps are far less complex than performing a full fledged re-encoding process as required in the pixel domain approach. The main computational bottlenecks of the full re-encoding process such as motion estimation, intra prediction estimation, prediction mode estimation and rate control are completely avoided. Rather, the stitcher re-uses the parameters that were estimated by the encoders that produced the QCIF bitstreams in the first place. Thus, the drift-free approach of the present invention presents an effective compromise between the pixel domain and compressed domain approaches.

From the description of the drift-free hybrid stitching approach, it should be apparent that the approach is not restricted to a single video coding standard for all the incoming bitstreams and the outgoing stitched bitstream. Indeed, the drift-free stitching approach will be applicable even when the incoming bitstreams conform to different video coding standards (such as two H.263 bitstreams, one H.261 bitstream and one H.264 bitstream); moreover, irrespective of the video coding standards used in the incoming bitsreams, the outgoing stitched bitstream can be designed to conform to any desired video coding standard. For instance, the incoming bitstreams can all conform to H.263, while the outgoing stitched bitstream can conform to H.264. The decoding portion of the drift-free hybrid stitching approach will decode the incoming bitstreams using decoders conforming to the respective video coding standards; the prediction parameters decoded from these bitstreams are then appropriately translated for the outgoing stitched video coding standard (e.g. if an incoming bitstream is coded using H.264 and the outgoing stitched bitstream is H.261, then multiple motion vectors for different partitions of a given macroblock in the incoming side have to be suitably translated to a single motion vector for the stitched bitstream); finally, the steps for forming the stitched predicted blocks and stitched decoded residual, and generating the stitched bitstream proceed according to the specifications of the outgoing video coding standard.

II. H.264 Drift-Free Hybrid Approach

An embodiment of the drift-free hybrid approach to video stitching may be specially adapted for H.264 encoded video images. The basic outline of the drift-hybrid stitching approach applied to H.264 video images is substantially the same as that described above. The incoming QCIF bitstreams are assumed to conform to the Baseline profile of H.264, and the outgoing CIF bitstream will also conform to the Baseline profile of H.264 (since the Baseline profile is of interest in the context of video conferencing). The proposed stitching algorithm produces only one video sequence. Hence, only one sequence parameter set is necessary. Moreover, the proposed stitching algorithm uses only one picture parameter set that will be applicable for every frame of the stitcher output (e.g. every frame will have the same slice group structure, the same chroma quantization parameter index offset, etc.) The sequence parameter set and picture parameter set will form the first two NAL units in the stitched bitstream. Subsequently, the only kind of NAL units in the bitstream will be Slice Layer without Partitioning NAL units. Each stitched picture will be coded using four slices, with each slice corresponding to a stitched quadrant. The very first outgoing access unit in the stitched bitsteam is an IDR access unit and by definition consists of four I-slices (since it conforms to the Baseline profile), and except in the very first access units of the stitched bitstream, all other access units will contain only P-slices. Each stitched picture in the stitched video sequence is sequentially numbered using the variable frame_index, starting with 0. That is, frame_index=0 denotes the very first picture (IDR) picture, while frame_index=1 denotes the first non-IDR access unit and so on.

A. H.264 Stitching Process in a Simple Stitching Scenario

The following outlines the detailed steps for the drift-free H.264 stitcher to produce each NAL unit. A simple stitching scenario is assumed where four input streams have exactly the same frame rate and arrive perfectly synchronized in time with respect to each other without encountering any losses during transmission. Moreover, the four input streams start and stop simultaneously; this implies that the IDR picture for each of the four streams arrive at the stitcher at the same instant, and the stitcher stitches these four IDR pictures to produce the outgoing IDR picture. At the next step, the stitcher is invoked with the next four access units from the four input streams, and so on. In addition, the simple stitching scenario also assumes that the incoming QCIF bitstreams always have the syntax elements ref_pic_list_reordering_flag_{—}10 and adaptive_ref_pic_marking_mode_flag set to 0. In other words, no reordering of reference picture lists or memory_management_control_operation (MMCO) commands are allowed in the simple scenario. The stitching steps will be enhanced in a later section to handle general scenarios. Note that even though the stitcher produces only one video sequence, each incoming bitstream is allowed to contain more than one video sequence. Whenever necessary, all slices in an IDR access unit in the incoming bitstreams will be converted to P-slices.

1. Sequence Parameter Set RBSP NAL Unit:

This will be the very first NAL unit in the stitched bitstream. The stitched bitstream continues to conform to the Baseline profile; this corresponds to a profile_idc of 66. The level_idc is set based on the expected output bitrate of the stitcher. As a specific example, the nominal bitrate of each incoming QCIF bitstream is assumed to be 80 kbps; for this example, a level of 1.3 (i.e. level_idc=13) is appropriate for the stitched bitstream because this level accommodates the nominal output bitrate of 4 times the input bitrate of 80 kbps and allows some excursion beyond it. When the nominal bitrate of each incoming QCIF bitstream is different from 80 kbps, the outgoing level can be appropriately determined in a similar manner. The MaxFrameNum to be used by the stitched bitstream is set to the maximum possible value of 65536. One or more of the incoming bitstreams may also use this value, hence short-term reference pictures could come from as far back as 65535 pictures. Picture order count type 2 is chosen. This implies that the picture order count is 2×n, for the stitched picture whose frame_index is n. The number of reference frames is set to the maximum possible value of 16 because one or more of the incoming bitstream may also use this value. No gaps are allowed in frame numbers, hence the value of syntax element frame_num for a slice in the stitched picture given by frame_index n will be given by n % MaxFrameNum, which is equal to n&0×FFFF (where 0×FFFF is hexadecimal notation for 65535). The resolution of a stitched picture will be CIF, i.e., width is 352 pixels and height is 288 pixels.

Throughout this discussion any syntax element for which there is no ambiguity is not explicitly mentioned, e.g. frame_mbs only_flag is always 1 for the baseline profile, and reserved zero_{—}5 bits is always 0. Therefore these syntax elements are not explicitly mentioned below. Based on the above discussion, the syntax elements are set as follows.

| | |
|---|---|
| profile_idc: | 66 |
| constraint_set0_flag: | 1 |
| constraint_set1_flag: | 0 |
| constraint_set2_flag: | 0 |
| level_idc: | determined based various |
| etc. | parameters such as out |
| | frame rate, output bitrate, |
| seq_parameter_set id: | 0 |
| log2_max_frame_num_minus4: | 12 |
| pic_order_cnt_type: | 2 |
| num_ref_frames: | 16 |
| gaps_in_frame_num_value_allowed_flag: | 0 |
| pic_width_in_mbs_minus1: | 21 |
| pic_height_in_map_units_minus1: | 17 |
| frame_cropping_flag: | 0 |
| vui_parameters_present_flag: | 0 |

The syntax elements are then encoded using the appropriate variable length codes (as specified in sub clauses 7.3.2.1 and 7.4.2.1 of the H.264 standard ) to produce the sequence parameter set RBSP. Subsequently, the sequence parameter set RBSP is encapsulated into a NAL unit by adding emulation_prevention_three_bytes whenever necessary (according to NAL unit semantics specified in sub clauses 7.3.1. and 7.4.1 of the H.264 standard).

2. Picture Parameter Set RBSP NAL Unit:

This will be the second NAL unit in the stitched bitstream. Each stitched picture will be composed of four slice groups, where the slice groups are spatially correspond to the quadrants corresponding to the individual bitstreams. The number of active reference pictures is chosen as 16, since the stitcher may have to refer to all 16 reference frames, as discussed before. The initial quantization parameter for the picture is set to 26 (as the midpoint in the allowed quantization parameter range of 0 through 51); individual quantization parameters for each macroblock will be modified as needed at the macroblock layer inside slice layer without partitioning RBSP. The relevant syntax elements are set as follows:

| | |
|---|---|
| pic_parameter_set_id: | 0 |
| seq_parameter_set_id: | 0 |
| num_slice_groups_minus1: | 3 |
| slice_group_map_type: | 6 |
| pic_size_in_map units_minus1: | 395 |
| slice_group_id[i]: | |
| | 0 for i ∈ {22 × m + n : 0 ≦ m < |
| | 9, 0 ≦ n < 11}, |
| | 1 for i ∈ {22 × m + n : 0 ≦ m < |
| | 9, 11 ≦ n < 22}, |
| | 2 for i ∈ {22 × m + n : 9 ≦ m < |
| | 18, 0 ≦ n < 11}, |
| | 3 for i ∈ {22 × m + n : 9 ≦ m < |
| | 18, 11 ≦ n < 22} |
| num_ref_idx_10_active_minus1: | 15 |
| pic_init_qp_minus26: | 0 |
| chroma_qp_index_offset: | 0 |
| deblocking_filter_control_present_{—} | 1 |
| flag: | |
| constrained_intra_pred_flag: | 0 |
| redundant_pic_cnt_present_flag: | 0 |

The syntax elements are then encoded using the appropriate variable length codes (as specified in sub clauses 7.3.2.2 and 7.4.2.2 of the H.264 standard ) to produce the picture parameter set RBSP. Subsequently, the picture parameter set RBSP is encapsulated into a NAL unit by adding emulation-prevention-three_bytes whenever necessary (according to NAL unit semantics specified in sub clauses 7.3.1 and 7.4.1 of the H.264 standard).

3. Slice Layer Without Partitioning RBSP NAL Unit:

All the NAL units in the stitched bitstream after the first two are of this type. Each stitched picture is coded as four slices with each slice representing a quadrant, i.e., each slice coincides with the entire slice group as set in the picture parameter set RBSP above. A slice layer without partitioning RBSP has two main components: slice header and slice data.

The slice header consists of slice-specific syntax elements, and also syntax elements needed for reference picture list reordering and decoder reference picture marking. The relevant slice-specific syntax elements are set as follows for the stitched picture for which frame_index equals n:

| | |
|---|---|
| first_mb_in_slice: | 0, 11, 198, or 209, if slice_group id[i] for each macroblock i in |
| | the given slice is 0, 1, 2, or 3 respectively |
| slice type: | 7 if n = 0, 5 if n ≠ 0 |
| pic_parameter_set_id: | 0 |
| frame_num: | n & 0xFFFF |
| idr_pic_id (when n = 0): | 0 |
| num_ref_idx_active_override_flag (when n ≠ 0): | 1, if n<16 and 0 otherwise |
| num_ref_idx_10_active_minus1 (when n ≠ 0): | min(n − 1,15) |
| slice_qp_delta: | 0 |
| disable_deblocking_filter_idc: | 2, if the total number of macroblocks in slices in the |
| | corresponding incoming bitstream for which the value of |
| | disable_deblocking_filter_idc was 0 or 2 is greater than or equal to 50 |
| | (corresponding to roughly 50% of the number of macroblocks in a QCIF picture). |
| | Otherwise, set the syntax element equal to 1. This choice for the syntax element |
| | disable_deblocking_filter_idc is a majority-based rule, and other choices will also |
| | work, e.g. distable_deblocking_filter_idc could be always set to 1, which will |
| | reduce computational complexity associated with deblocking operation both at the |
| | outgoing side of the stitcher as well as in the receiving appliance that decodes the |
| | stitched bitstream. |

The relevant syntax elements for reference picture list reordering are set as follows: ref_pic_list_reordering_flag_{—}10: 0

The relevant syntax elements for decoded reference picture marking are set as follows:

| | |
|---|---|
| no_output_of_prior_pics_flag (when n = 0): | 0 |
| long_term_reference_flag (when n = 0): | 0 |
| adaptive_ref_pic_marking_mode_flag (when n ≠ 0): | 0 |

The above steps set the syntax elements that constitute the slice header. Before setting the syntax elements for slice data, the following process must be performed on each macroblock of the CIF picture to obtain the initial settings for certain parameters and syntax elements (these settings are “initial” because some of these settings may eventually be modified as discussed below). The syntax elements for each macroblock of the stitched frame are set next by using the information (syntax element or decoded attribute) from the corresponding macroblock in the current ideal stitched picture. For this purpose, the macroblock/block that is spatially located in the ideal stitched frame at the same position as the current macroblock/block in the stitched picture will be referred to as the co-located macroblock/block. Note that the word co-located used here should not be confused with the word co-located used in the context of decoding of direct mode for B-slices, in subclause 8.4.1.2.1 in the H.264 standard.

For frame_index equal to 0 (i.e. the IDR picture produced by the stitcher), the syntax element mb_type is set equal to mb_type of the co-located macroblock.

For frame_index not equal to 0 (i.e. non-IDR picture produced by the stitcher), the syntax element mb_type is set as follows:

If co-located macroblock belongs to an I-slice, then set mb_type equal to 5 added to the mb_type of the co-located macroblock.

Otherwise, if co-located macroblock belongs to a P-slice, then set mb_type equal to mb_type of the co-located macroblock. If the inferred value of mb_type of the co-located macroblock is P_SKIP, set mb_type to −1.

If the macroblock prediction mode (given by MbPartPredMode( ), as defined in Tables 7-8 and 7-10 in the H.264 standard) of the mb_type set above is Intra_{—}4×4, then for each of the constituent 16 4×4 luma blocks set the intra 4×4 prediction mode equal to that in the collocated block of the ideal stitched picture. Note that the actual intra 4×4 prediction mode is set here, and not the syntax elements prev_intra4×4_pred_mode_flag or rem_intra4×4_pred_mode.

If the macroblock prediction mode of the mb_type set above is set to Intra_{—}4×4 or Intra_{—}16×16, then the syntax element intra_chroma_pred_mode is set equal to intra_chroma_pred_mode of the co-located macroblock.

If the macroblock prediction mode of the mb_type set above is not Intra_{—}4×4 or Intra16×16 and if number of macroblock partitions (given by NumMbPart( ), as defined in Table 7-10 in the H.264 standard) of the mb_type is less than 4, then for each of the partitions of the macroblock set the reference picture index equal to that in the co-located macroblock partition. If the mb_type set above does not equal −1 (implying that the macroblock is not a P_SKIP), then both components of the motion vector must be set equal to those in the co-located macroblock partition of the ideal stitched picture. Note that the actual motion vector is set here, not the mvd_{—}10 syntax element. If the mb_type equals −1 (implying P_SKIP), then both components of the motion vector must be set to the predicted motion vector using the process outlined in sub clause 8.4.1.3 of the H.264 standard. If the resulting motion vector takes any part of the current macroblock outside those boundaries of the current quadrant which are shared by other quadrants, the mb_type is changed from P_SKIP to P_L0_{—}16×16.

If the macroblock prediction mode of the mb_type set above is not Intra_{—}4×4 or Intra_{—}16×16 and if number of macroblock partitions of the mb_type is equal to 4, then for each of the four partitions of the macroblock. The syntax element sub_mb_type is set equal to that in the co-located partition of the ideal stitched picture. Then, for each of the sub macroblock partitions, the reference picture index and both components of the motion vector are set equal to those in the co-located sub macroblock partition of the ideal stitched picture. Again, the actual motion vector is set here and not the mvd_{—}10 syntax element.

The parameter MbQpY is set equal to the luma quantization parameter used in residual decoding process in the co-located macroblock of the ideal stitched picture. If no residual was decoded for the co-located macroblock (e.g. if coded_block_pattern was 0 and the macroblock prediction mode of the mb_type set above is not INTRA_{—}16×16, or it was a P_SKIP macroblock), then MbQpY is set to the MbQpY of the previously coded macroblock in raster scanning order inside that quadrant. If the macroblock is the very first macroblock of the quadrant, then the value of (26+pic_init_qp_minus26+slice_qp_delta) is used, where pic_init_qp_minus26 and slice_qp_delta are the corresponding syntax elements in the corresponding incoming bitstream. After completing the above initial settings, the following process is performed over each macroblock for which mb_type is not equal to I_PCM.

The stitched predicted blocks are now formed as follows. If the macroblock prediction mode of the mb_type set above is Intra_{—}4×4, then for each of the 16 constituent 4×4 luma blocks in 4×4 luma block scanning order, perform Intra 4×4 prediction (according to the process defined in sub clause 8.3.1.2 of the H.264 standard ), using the Intra_{—}4×4 prediction mode set above using the neighboring stitched reconstructed blocks already formed prior to the current block in the stitched picture. If the macroblock prediction mode of the mb_type set above is Intra_{—}16×16, perform Intra_{—}16×16 prediction (according to the process defined in sub clause 8.3.2 of H.264 ), using the intra 16×16 prediction mode information contained in the mb_type as set above, using the neighboring stitched reconstructed macroblocks already formed prior to the current block in the stitched picture. In either of the above two cases, perform intra prediction process for chroma samples, according to the process defined in sub clause 8.3.3 of the H.264 standard using already decoded blocks/macroblocks in a causal neighborhood of the current block/macroblock. If the macroblock prediction mode of the mb_type is neither Intra_{—}4×4 nor Intra_{—}16×16, then for each constituent partition in scanning order, perform inter prediction (according to the process defined in sub clause 8.4.2.2 of the H.264 standard ), using the motion vector and reference picture index information set above. The reference picture index set above is used to select a reference picture according to the process described in sub clause 8.4.2.1 of the H.264 standard, but applied on the stitched reconstructed video sequence instead of the ideal stitched video sequence.

The stitched raw residual blocks are formed as follows. The 16 stitched raw residual blocks are obtained by subtracting the corresponding predicted block obtained as above from the co-located ideal stitched block.

The quantized and transformed coefficients are formed as follows. Use the forward transform and quantization process (appropriately designed for each macroblock type logically equivalent to the implementation in H.264 Reference Software ), to obtain quantized transform coefficients.

The stitched decoded residual blocks are formed as follows. According to the process outlined in sub clause 8.5 of the H.264 standard, decode the quantized transform coefficients obtained in the earlier step. This forms the 16 decoded stitched decoded residual luma blocks, and the corresponding 4 stitched decoded Cb blocks and 4 Cr blocks.

The stitched reconstructed blocks are formed as follows. The stitched decoded residual blocks obtained above are added to the respective stitched predicted blocks to form the stitched reconstructed blocks for the given macroblock.

Once the entire stitched picture is reconstructed, a deblocking filter process is applied using the process outlined in sub clause 8.7 of the H.264 standard. This is followed by a decoded reference picture marking process as per sub clause 8.2.5 of the H.264 standard. This yields the stitched reconstructed picture.

The relevant syntax elements needed to encode the slice data are as follows:

Slice data specific syntax elements are set as follows:

| | |
|---|---|
| mb_skip_run | Count the number of consecutive macroblocks |
| (when n ≠ 0): | that have mb_type equal to P_SKIP. This |
| | number is assigned to this syntax element. |

Macroblock layer specific syntax elements are set as follows:

| | |
|---|---|
| pcm_byte[i], | Set equal to pcm_byte[i] in |
| for 0 ≦ i < 384 (when | the co-located macroblock of the ideal stitched picture. |
| mb_type is I_PCM): | |
| coded_block_pattern: | This is a six bit field. If the macroblock prediction mode of the |
| | mb_type set previously is Intra_16x16, then the right four bits are set equal to 0 if |
| | all the Intra_16x16 DC and Intra_16x16 AC coefficients (obtained from forward |
| | transform and quantization of stitched raw residual) are 0; otherwise all the four |
| | bits are set equal to 1. If the macroblock prediction mode of the mb_type set |
| | previously is Intra_4x4, then the i ^{th} bit from the right is set to 0 if all the |
| | quantized transform coefficients for all the 4 blocks in the 8x8 macroblock |
| | partition indexed by i are 0. Otherwise, this bit is set to 1. In either Intra_16x16 |
| | or Intra_4x4 cases, if all the chroma DC and the chroma AC coefficients are 0, |
| | then the left two bits are set to 00. If all the chroma AC coefficients are 0 and at |
| | least one chroma DC coefficient is not 0, then the left two bits are set to 01. |
| | Otherwise the left two bits are set to 10. The parameter CodedBlockPattemLuma |
| | is computed as coded_block_pattern%15. |
| mb_type: | The initial setting for this syntax element has already been done above. If |
| | the macroblock prediction mode of the mb_type set previously is Intra_16x16 |
| | then mb_type needs to be modified based on the value of |
| | CodedBlockPattemLuma (as computed above) using Table 7.8 in the H.264 |
| | standard. Note that if the value of mb_type is set to −1, it is not entropy encoded |
| | since it corresponds to a P_SKIP macroblock and so the mb_type is implicitly |
| | captured in mb_skip_run. |
| mb_qp_delta (only | If current macroblock is the very |
| set when either the | first macroblock in the slice, then mb_qp_delta is set by subtracting 26 from |
| macroblock prediction | MbQpY set earlier for this macroblock. For other macroblocks, mb_qp_delta is |
| mode of the mb_type | set by subtracting MbQpY of the previous macroblock inside the slice from the |
| is Intra16x16 or if | MbQpY of the current macroblock. |
| coded_block_{—} | |
| pattern is not 0): | |

Macroblock prediction specific syntax elements are set as follows:

| | |
|---|---|
| prev_intra4x4_pred_mode_flag (when the macroblock | Set to 1 if intra 4x4 prediction mode for the current block |
| prediction mode of the mb_type is Intra4x4): | equals the predicted value given by the variable predIntra4x4PredMode that is |
| | computed based on neighboring blocks, as per sub clause 8.3.1.1 of the H.264 |
| | standard. |
| rem_intra4x4_pred_mode (when the macroblock | Set to the actual |
| prediction mode of the mb_type is Intra_4x4 and | intra 4x4 prediction mode, if it is less than the predicted value given by |
| prev_intra4x4_pred_mode_flag is set above to 0): | predIntra4x4PredMode. Otherwise, it is set to one less than the actual intra 4x4 |
| | prediction mode. |
| intra_chroma_pred_mode (when the macroblock | Already set above. |
| prediction mode of the mb_type is Intra_4x4 or Intra_{—} | ref_idx_10 (when the macroblock prediction mode of the mb_type is neither |
| 16x16): | Already set above. |
| Intra_4x4 nor Intra_16x 16): | |
| mvd_10 (when the macroblock prediction mode of the | Set by subtracting the predicted motion vector using |
| mb_type is neither Intra_4x4 nor Intra_16x16): | neighboring partitions (as per sub clause 8.4.1.3 of the H.264 standard ) from the |
| | motion vector set earlier for this partition. |

Sub-macroblock prediction specific syntax elements are set as follows:

| | |
|---|---|
| sub_mb_type: | Already set above. |
| ref_idx_10: | Already set above. |
| mvd_10: | Set in a similar manner as described for macroblock |
| | prediction specific syntax elements. |

Residual block CAVLC specific syntax elements are set as follows:

The syntax elements for this are set using the CAVLC encoding process
(logically equivalent to the implementation H.264 Reference Software ).
The slice layer without partitioning RBSP this formed is encapsulated into
a NAL unit by adding emulation_prevention_three_bytes whenever
necessary (according to NAL unit semantics specified in sub clauses 7.3.1
and 7.4.1 of the H.264 standard ). The above steps complete the
description of H.264 drift-free stitching in simple stitching scenario. The
enhancements needed for a general stitching scenario are described in the
next section.

B. H.264 Stitching Process in a General Stitching Scenario

The previous section provided a detailed description of H.264 stitching in the simple stitching scenario where the incoming bitstreams are assumed to have identical frame rates and all of the video frames from each bitstream are assumed to arrive at the stitcher at the same time. This section adds further enhancements to the H.264 stitching procedure for a more general scenario in which the incoming video streams may have different frame rates, with video frames that may be arriving at different times, and wherein video data may occasionally be lost. Like in the simple scenario, there will continue to be two distinct and different operations that take place within the stitcher, namely, decoding the incoming QCIF video bitstreams and the rest of the stitching procedure. The decoding operation entails four logical decoding processes, i.e., one for each incoming stream. Each of these processes or decoders produces a frame at the output. The rest of the stitching procedure takes the available frames, and combines and codes them into a stitched bitstream. The distinction between the decoding step and the rest of the stitching procedure is important and will be maintained throughout this section.

In the simple stitching scenario, the four input streams would have exactly the same frame rate (i.e. the nominal frame rate agreed to at the beginning of the video conference) and the video frames from the input streams would arrive at the stitcher perfectly synchronized in time with respect to one another without encountering any losses. In reality, however, videoconferencing appliances or endpoints join/leave multipoint conferences at different times. They produce wavering non-constant frame rates (dictated by resource availability, texture and motion of the scene being encoded, etc), and bunch packets together in time (instead of spacing them apart uniformly), and so forth. The situation is exacerbated by the fact that the network introduces a variable amount of delay on the packets as well as packet losses. A practical stitching system therefore requires a robust and sensible mechanism forhandling the inconsistencies and vagaries of the separate video bitstreams received by the stitcher.

The following issues need to be considered in developing a proper robust stitching methodology:
1. Lost packets in the incoming streams
2. Erratic arrival times of the packets in the incoming streams
3. Frame rate of one or more of the incoming streams exceeds the nominal value
4. Finite resources available to the stitcher
5. Incoming streams (i.e., the corresponding endpoints) join and/or leave the call at different times
6. Incoming streams may use reference picture list reordering and MMCO commands (i.e. syntax elements ref_pic_list_reordering_flag_{—}10 and adaptive_ref_pic_marking_mode_flag need not be 0). Note that the simple stitching scenario assumed no reordering of reference picture lists and MMCO commands.

According to the present invention the stitcher employs the following techniques in order to address the issues described above:
1. Stitching is performed only on fully decoded frames. This means that when it is time to stitch, only those frames are considered for stitching that have been fully decoded and indicated as such by the decoders. In the case of packet losses in the incoming streams, it is up to the individual decoder to do appropriate error concealment to get the frame ready for stitching. In summary, it is the individual decoder's responsibility to make a decoded frame available and indicate as such to the stitching operation. The error concealment to be used by the decoder is strictly not a stitching issue and so the description of an error concealment procedure that the decoder can use is provided in a separate section after the description of H.264 stitching in a general scenario.
2. The time instants at which the stitching operations are invoked are determined as follows.
   a) The parameter fₙₒₘ will be used to denote the nominal frame rate agreed to by the MCU and the endpoints in the call set-up phase.
   b) The parameter fₘₐₓ will be used to denote the maximum stitching frame rate, i.e., the maximum frame rate that the stitcher can produce.
   c) The parameter tₜₐᵤ will be used to denote the time elapsed since the last stitching time instant until two complete access units (both of which have not been used in a stitching operation) have been received in one of the four incoming streams.
   d) Then, the waiting time (time to stitch), tₜₛ, since the last stitching operation until the next stitching operation is given by:
      tₜₛ=max(min(1/fₙₒₘ, tₜₐᵤ), 1/fₘₐₓ)

In the simple scenario the endpoints produce streams at unvarying nominal frame rates and packets arrive at the stitcher at uniform intervals. In these conditions the stitcher can indeed operate at the nominal frame rate at all times. In reality, however, the frame rates produced by the various endpoint can vary significantly around the nominal frame rate and/or on average can be substantially higher than the nominalframe rate. According the present invention, the stitcher is designed to stitch a frame in the stitched video sequence whenever two complete access units, i.e., frames, are received in any incoming stream. This means that the stitcher will attempt to keep pace with a faster than nominal frame rate seen in any of the incoming streams. However, it should be kept in mind that in a real world system the stitcher has access to only a finite amount of resources, the stitcher can only stitch as fast as the resources will allow it. Therefore, a protection mechanism is provided in the stitching design through the specification of the maximum stitching frame rate parameter, fₘₐₓ. In this case, whenever one of the incoming streams tries to drive up the stitching frame rate beyond fₘₐₓ, the stitcher drops packets corresponding to complete access unit(s) in the offending stream so as to not exceed its capability. Note, however, that the corresponding frame still needs to be decoded by the decoder portion of the stitcher, although this frame is not used to form a stitched CIF picture.

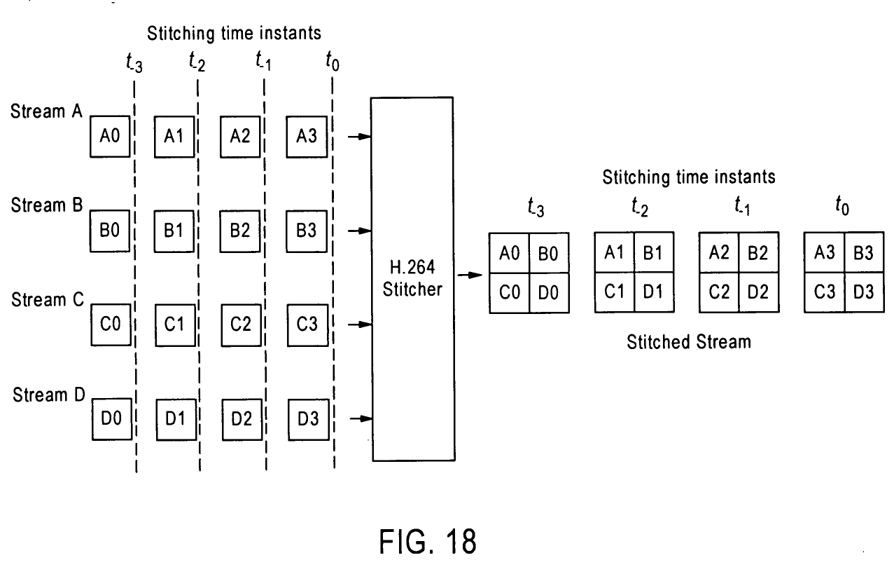

In order to get a better idea of what exactly goes into stitching together the incoming streams, it is instructive to look at some illustrative examples. FIG. 18 shows the simple stitching scenario where incoming streams are in perfect synchrony with the inter-arrival times of the frames in each stream corresponding exactly to the nominal frame rate, fₙₒₘ. The figure shows four streams:
1. Stream A shows 4 frames or access units→A0, A1, A2, A3
2. Stream B shows 4 frames or access units→B0, B1, B2, B3
3. Stream C shows 4 frames or access units→C0, C1, C2, C3
4. Stream D shows 4 frames or access units→D0, D1, D2, D3

In this case, the stitcher can produce stitched frames at the nominal frame rate with the frames stitched together at different time instants as follows:
t₃: A0, B0, C0, D0
t₂: A1, B1, C1, D1
t₋₁: A2, B2, C2, D2
t₀: A3, B3, C3, D3

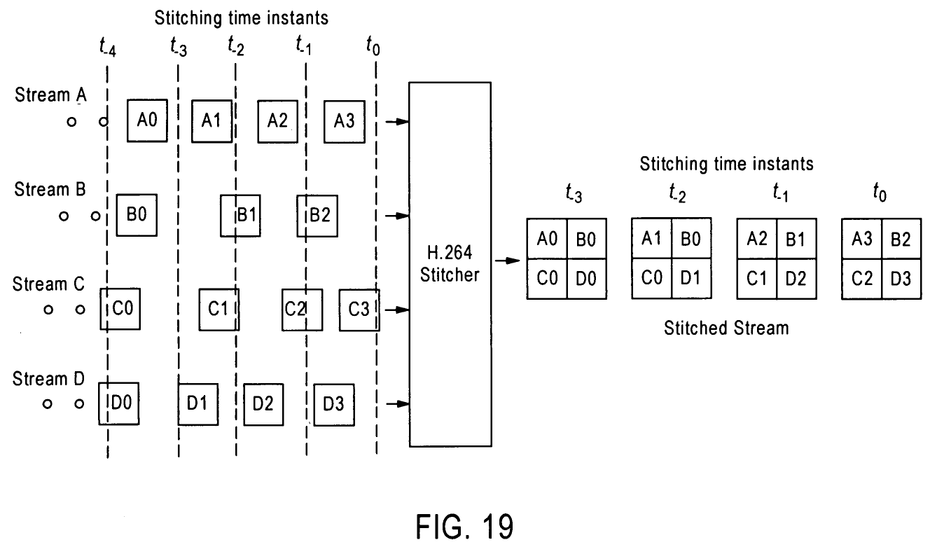

Now, consider the case of asynchronous incoming streams illustrated in FIG. 19. The stitching operation proceeds to combine whatever is available from each stream at a given stitching time instant. The incoming frames are stitched as follows:
t₋₃: A0, B0, C0, D0
t₋₂: A1, B0, C0, D1
t₋₁: A2, B1, C1, D2
t₀: A3, B2, C2, D3

At time instant t₋₃, new frames are available from each of the streams, i.e., A0, B0, C0, D0 and therefore are stitched together. But at t₋₂, new frames are available from streams A and D, i.e., A1, D1 but not from B and C. Therefore, the temporally previous frames from these streams, i.e., B0, C0 are repeated at t₋₃. In order to repeat the information in the previous quadrant, some coded information has to be invented by the stitcher so that the stitched stream carries this information. The H.264 standard offers a relatively easy solution to this problem through the availability of the concept of a P_SKIP macroblock. A P_SKIP macroblock carries no coded residual information and is intended as a copying mechanism from the most recent reference frame into the current frame. Therefore, a slice (quadrant) consisting of all P_SKIP macroblocks will provide an elegant and inexpensive solution to repeating a frame in one of the incoming bitstreams. The details of the construction of such a coded slice, referred to as MISSING_P_SLICE_WITH_P_SKIP_MBS, is described below.

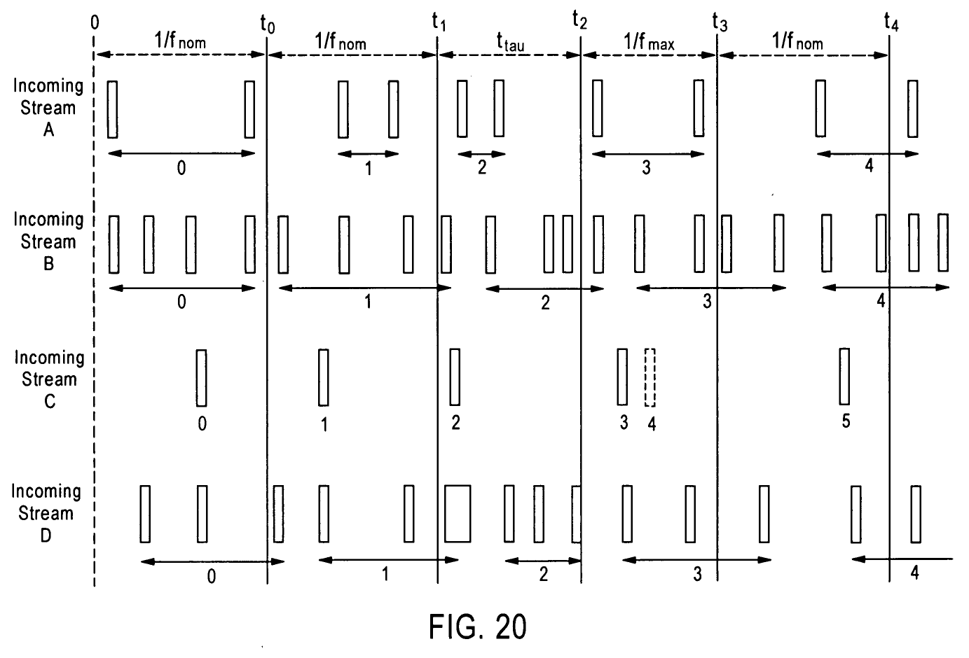

In the following discussion, the stitching of asynchronous incoming streams is described in a more detailed manner. The discussion assumes a packetized video stream, comprising a collection of coded video frames with each coded frame packaged into one or more IP packets for transmission. This assumption is consistent with most real world video conference applications. Consider the example shown in FIG. 20. The incoming QCIF streams are labeled A, B, C, D with
A: 1 access unit (frame)=2 IP packets
B: 1 access unit (frame)=4 IP packets
C: 1 access unit (frame)=1 IP packets
D: 1 access unit (frame)=3 IP packets

The stitching at various time instants proceeds as follows:
t₀: A0, B0, C0
t₁: A1, C1, D0
t₂: A2, B1, C2, D1
t₃: A3, B2, C3, D2
t₄: B3, C5, D3 (C4 dropped)

Some important observations regarding this example are:
t₀, t₁, t₄: Correspond to nominal stitching frame rate, fₙₒₘ
t₂: A stitching instant due to the reception of two complete access units (D1, D2)
t₃: Corresponds to maximum stitching frame rate, fₘₐₓ
t₄: C4 is dropped because C5 becomes available

Stitching cannot be performed after reception of C4 (second complete access unit following C3) since that would exceed fₘₐₓ.

When a multipoint call is established, all of the endpoints involved do not join at the same time. Similarly, some of the endpoints may quit the call before the others. Therfore, whenever a quadrant is empty i.e. no participant is available to be displayed in that quadrant, some information needs to be displayed by the stitcher. This information is usually in the form of a gray image or a static logo. As a specific example, a gray image will be assumed for the detailed description here. However, any other image can be substituted by making suitable modifications without departing from the spirit and scope of the details presented here. Such a gray frame has to be coded as a slice and inserted into the stitched stream. Following are the three different types of coded slices (and the respective scenarios where they are necessary) that have to be devised:
1. MISSING_IDR_SLICE: This I-slice belonging to an IDR-picture is necessary if the gray frame has to be inserted into the very first frame of the stitched stream.
2. MISSING_P_SLICE_WITH_I_MBS: This slice is necessary for the stitched frame that immediately follows the end of a particular incoming stream, i.e., one of the endpoints has quit the call and so the corresponding quadrant has to be taken care of.
3. MISSING_P_SLICE_WITH_P_SKIP_MBS: This slice is used whenever there is a need to simply repeat the temporally previous frame. It is used on two different occasions: (a) In all subsequent frames following the stitched frame containing a MISSING_IDR_SLICE for a quadrant, this slice is used for that same quadrant until an endpoint joins the call so that its video can be fed into the quadrant, and (b) In all subsequent frames following the stitched frame containing a MISSING_P_SLICE_WITH_I_MBS for a quadrant, this slice is employed for that same quadrant until the end of the call.

Although it is possible to use MISSING_P_SLICE_WITH_I_MBS in non-IDR stitched frames for as long as necessary, it is advantageous to use MISSING_P_SLICE_WITH_P_SKIP_MBS because it consumes less bandwidth and more importantly, it is much easier to decode for the endpoints receiving the stitched stream.

The parameter slice_ctr takes the values 0, 1, 2, 3 corresponding respectively to the quadrants A, B, C, D shown in FIG. 1.

The MISSING_IDR_SLICE is constructed such that when it is decoded, it produces an all-gray quadrant whose Y, U, and V samples are all equal to 128. The specific syntax elements for the MISSING_IDR_SLICE are set as follows:

Slice Header syntax elements:

| | | |
|---|---|---|
| first_mb_in_slice: | 0 | if slice_ctr = 0 |
| | 11 | if slice_ctr = 1 |
| | 198 | if slice_ctr = 2 |
| | 209 | if slice_ctr = 3 |
| slice_type: | 7 (I-slice) | |
| picture_parameter_set_id: | 0 | |
| frame_num: | 0 | |
| idr_pic_id: | 0 | |
| slice_qp_delta: | 0 | |
| disable_deblocking_filter_idc: | 1 | |

Decoded reference picture marking syntax elements are set as follows:

| | |
|---|---|
| no_output_of_prior_pics_flag: | 0 |
| long_term_reference_flag: | 0 |

Marcoblock layer syntax elements are set as follows:

| mb_type: | 0 (I_4x4_MB in a I-slice) |
|---|---|
| coded_block_pattern: | 0 |

Macroblock prediction syntax elements are set as follows:

| prev_intra4x4_pred_mode_flag: | 1 for every 4x4 luma block |
|---|---|
| intra_chroma_pred_mode: | 0 |

The MISSING_P_SLICE_WITH_I_MBS is constructed such that when it is decoded, it produces an all-gray quadrant whose Y, U, and V samples are all equal to 128. The specific syntax elements for the MISSING_P_SLICE_WITH_I_MBS are set as follows:

Slice Header syntax elements are set as follows:

| | | |
|---|---|---|
| first_mb_in_slice: | 0 | if slice_ctr = 0 |
| | 11 | if slice_ctr = 1 |
| | 198 | if slice_ctr = 2 |
| | 209 | if slice_ctr = 3 |
| slice_type: | 5 (P-slice) | |
| picture_parameter_set_id: | 0 | |
| frame_num: | n % 0xFFFF | |
| num_ref_idx_active_override_flag: | 1, if n < 16, 0 | |
| | otherwise | |
| num_ref_idx_10_active_minus1: | min(n − 1, 15) | |
| slice_qp_delta: | 0 | |
| disable_deblocking_filter_idc: | 1 | |

Reference picture reordering syntax elements are set as follows:
ref_pic_list_reordering_flag_{—}10: 0

Decoded reference picture marking syntax elements are set as follows:
adaptive_ref_pic_marking_mode_flag: 0

Slice data syntax elements are set as follows:
mb_skip_run=0

Macroblock layer syntax elements are set as follows:

| mb_type: | 5 (I_4x4_MB in a P-slice) |
|---|---|
| coded_block_pattern: | 0 |

Macroblock prediction syntax elements are set as follows:

| prev_intra4x4_pred_mode_flag: | 1 for every 4x4 luma block |
|---|---|
| intra_chroma_pred_mode: | 0 |

Note that instead of MISSING_P_SLICE_WITH_I_MBS, a MISSING_I_SLICE_WITH_I_MBS could also be alternatively used (with a minor change in mb_type setting).

The MISSING_P_SLICE_WITH_P_SKIP_MBS is constructed such that the information for the slice (quadrant) is copied exactly from the previous reference frame. The specific syntax elements for the MISSING_P_SLICE_WITH_P_SKIP_MBS are set as follows:

Slice header syntax elements are set the same as that of
MISSING_P_SLICE_WITH_I_MBS.

Slice data syntax elements are set as follows:
mb_skip_run: 99 (number of macroblocks in a QCIF frame)

One interesting problem that arises in stitching asynchronous streams is that the multi-picture reference buffer seen by the stitching operation will not be aligned with those seen by the individual QCIF decoders. In other words, assume that a given macroblock partition in a certain QCIF picture in one of the incoming streams used a particular reference picture (as given by the ref_idx_{—}10 syntax element coded for that macroblock partition) for inter-prediction. This same picture then goes on to occupy a quadrant in the stitched CIF picture. The reference picture in the stitched reconstructed video sequence that is referred to by the stored ref_idx_{—}10 may not temporally match the reference picture that was used for generating the ideal stitched video sequence. However, having said this, the proposed drift-free stitching approach (the drift here referring to that between the stitcher and the CIF decoder) will handle this scenario perfectly well. The only penalty paid for not making an attempt to try and align the reference buffers of the incoming and the stitched streams is an increase in the bitrate of the stitched output. This is because the different reference picture used along with the original motion vector during stitching may not provide a good prediction for a given macroblock partition. Therefore, it is well worth the effort to accomplish as much alignment of the reference buffers as possible. Specifically, this alignment will involve altering the syntax element ref_idx_{—}10 found in inter-coded blocks of the incoming picture so as to make it consistent with the stitched stream.

In order to keep the design simple, it is desired that the stitched output bitstream not use reference picture reordering or MMCO commands (as in the simple stitching scenario). As a result, a similar alignment issue can occur when the incoming QCIF pictures use reference picture reordering in their constituent slices and/or MMCO commands, even if there was no asynchrony in the incoming streams. For example, in the incoming stream, ref_idx_{—}10=2 in one QCIF slice may refer to the reference picture that was decoded temporally immediately prior to it. But since there is no reordering of reference pictures in the stitched bitstream, ref_idx_{—}10=2 will refer to the reference picture that is three pictures temporally prior to it. Even more serious alignment issues arise when incoming QCIF bitstreams use MMCO commands.

The alignment issues described above can be addressed by mapping the reference picture buffers between the four incoming streams and the stitched stream, asset forth below. Prior to that, however, it is important to review some of the properties of the stitched stream with respect to inter prediction:
1. No long-term reference pictures are allowed
2. No reordering of the reference picture list is allowed
3. No gaps are allowed in the numbering of frames
4. A reference buffer of 16 reference pictures is always maintained (once 16 pictures become available)
5. Maintenance of the reference picture buffer happens through the default sliding window process (i.e. no MMCO commands)

As for mapping short-term reference pictures in the incoming streams to those in the stitched stream, each short-term reference picture can be uniquely identified by frame_num. Therefore, a mapping can be established between the frame_num of each of the incoming streams and the stitched stream. Four separate tables are maintained at the stitcher, each carrying the mapping between one of the incoming streams and the stitched stream. When a frame is stitched, the ref_idx_{—}10 found in each inter-coded block of the incoming QCIF picture is altered using the appropriate table in order to be consistent with the stitched stream. The tables are updated, if necessary, each time a stitched frame is generated.

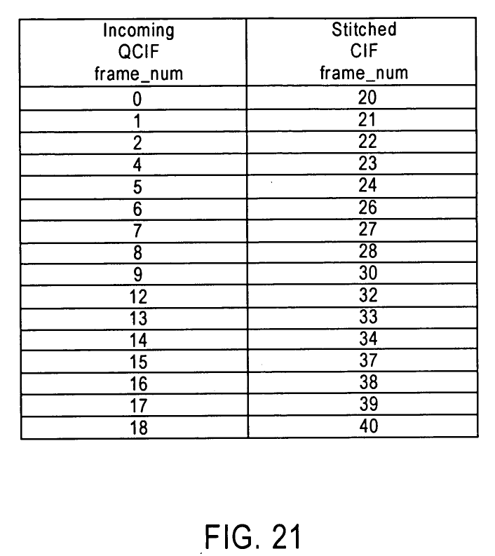

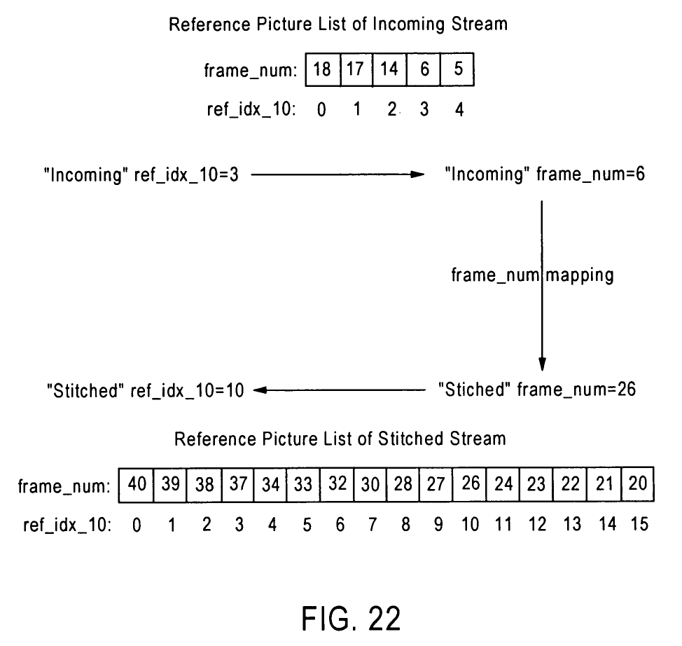

It would be useful at this time to understand the mapping set forth previously thorough an example. FIG. 21 shows an example of a mapping between an incoming stream and the stitched stream as seen by the stitcher after stitching the 41st frame (stitched frame_num=40). A brief review of the table reveals several jumps in frame_num in the case of both the incoming and the stitched streams. The incoming stream shows jumps because in this example it is assumed that the stream has gaps in frame numbering (gaps_in_frame_num_value_allowed_flag=1). Jumps in frame numbering exist in the stitched stream because stitching happens regardless of whether a new frame is available from a particular incoming stream or not (remember that gaps_in_frame_num_value_allowed_flag=0 in the stitched stream). To drive home this point, consider the skip in frame_num of the stitched stream from 24 to 26. This reflects the fact that no new frame was contributed by this incoming stream during the stitching of frame_num equal to 25 (and the stitcher output uses MISSING_P_SLICE_WITH_P_SKIP_MBS for that quadrant). The other observation that is of interest is that a frame_num of 0 in the incoming stream gets mapped to a frame_num of 20 in the stitched stream. This may, among other things, allude to the scenario where this incoming stream has joined the call only after 20 frames have already been stitched. FIG. 22 shows an example of how the ref_idx_{—}10 in the incoming picture is changed into the new ref_idx_{—}10 that will reside in the stitched picture.

One consequence of the modification of ref_idx_{—}10 syntax element is that a macroblock that was originally of type P_{—}8×8ref0 needs to be changed to P_{—}8×8 if the new ref_idx10 is not 0.

The above procedure for mapping of short-term reference pictures from incoming streams to the stitched bitstream need to be augmented in cases where an incoming QCIF frame is decoded but is dropped from the output of the stitcher due to limited resources at the stitcher. Recall, resource limitations may force the stitcher to maintain its output frame rate below fmax (as discussed earlier). As an example, continuing beyond the example shown in Table 1, suppose incoming frame_num=19 for the given incoming stream is decoded but is dropped from the stitcher output, and instead incoming frame_num=20 is stitched into stitched CIF frame_num=41. Suppose a macroblock partition in the incoming frame_num=20 used the dropped picture (frame_num=19) as reference. In this case, a mapping from incoming frame_num=19 would need to be artificially created such that it maps to the same stitched frame_num as the temporally previous incoming frame_num. In the example, the temporally previous incoming frame_num is 18, and that maps to stitched frame_num of 40. Hence, the incoming frame_num=19 will be artificially mapped to stitched frame_num of 40.

The long-term reference pictures in the incoming streams are mapped to the short-term reference pictures in the stitched CIF stream as follows. The ref_idx_{—}10 of a long-term reference picture in any of the incoming streams is mapped to min(15, num_ref_idx_{—}10_active_{—minus}1). The minimum of 15 and num_ref_idx_{—}10_active_minus1 is needed because the number of reference pictures in the stitched stream does not reach 16 until that many pictures are output by the stitcher. The rationale of picking the 15th slot in the reference picture list is that such a slot is reasonably expected to contain the temporally oldest frame. Since no long-term pictures are allowed in the stitched stream, the temporally oldest frame in the reference picture buffer is the logical choice to approximate a long-term picture in an incoming stream.

This completes the description of H.264 stitching in a general scenario. Note that the above description will be easily applicable to other resolutions such as for stitching four CEF bitstreams to a 4CIF bitstream with minor changes in the details.

A simplification in H.264 stitching is possible when one or more incoming quadrants are coded using only I-slices and the total number of slice groups in the incoming quadrants is less than or equal to 4 plus the number of incoming quadrants coded using only I-slices, and furthermore all the incoming quadrants that are coded using only I-slices have the same value for the syntax element chroma_qp_index_offset in their respective picture parameter sets (if there is only one incoming quadrant that is coded using only I-slices, the condition on the syntax element chroma_qp_index_offset is automatically satisfied). As a special example, the conditions for the simplified stitching are satisfied when the stitcher produces the very first IDR stitched picture and the incoming quadrants are also IDR pictures with the total number of slice groups in the incoming quadrants being less than or equal to 8 and the incoming quadrants using a common value for chroma_qp_index_offset. When the conditions for the simplified stitching are satisfied, there is no need for forming the stitched raw residual, and subsequently forward transforming and quantizing it, in the quadrants that were coded using only I-slices. For these quadrants, the NAL units as received from the incoming streams can therefore be sent out by the stitcher with only a few changes in the slice header. Note that more than one picture parameter sets may be necessary—this is because if the incoming bitstreams coded using only I-slices has a slice group structure different from interleaved (i.e. slice_group_map_type is not 0), the slice group structure for those quadrants can not be captured using the slice group structure derived using the syntax element settings described above for the picture parameter set for the stitched bitstream. The few changes required to the slice header will be as follows—firstly, the first_mb_in_slice syntax element has to be appropriately mapped from the QCIF to point to the correct location in the CIF picture; secondly, if incoming slice_type was 7, it may have to be changed to 2 (both 2 and 7 represent I-slice, but 7 means that all the slices in the picture are of type 7, which will not be true unless all the four quadrants use only I-slices); pic_parameter_set_id may have to be changed from its original value to point to the appropriate picture parameter set that is used in the stitching direction; thirdly, slice_qp_delta may have to be appropriately changed so that the SliceQPY computed as 26+pic_init_qp_minus26+slice_qp_delta (with pic_init_qp_minus26 as set in the stitched picture parameter set in use) equals the SliceQPY that was used for this slice in the incoming bitstream; furthermore, frame_num and contents of ref_pic_list_reordering and dec_ref_pic_marking syntax structures have to be set as described in detail earlier under the settings for slice layer without partitioning RBSP NAL unit. In addition, further simplification can be accomplished by setting disable_deblocking_filter_idc to 1 in the slice header. The stitched reconstructed picture is obtained as follows: For the quadrants that were coded using only I-slices in the incoming bitstreams, the corresponding QCIF pictures obtained “prior to” the deblocking step in the respective decoders are placed in the CIF picture; other quadrants (i.e. not coded using only I-slices) are formed using the method described in detail earlier that constructs the stitched reconstructed blocks; the CIF picture thus obtained is deblocked to produce the stitched reconstructed picture. Note that because there is no inter-coding used in I-slices, the decoder of the stitched bitstream produces a picture identical to the stitched picture obtained in this manner. Hence, the basic premise of drift-free stitching is maintained. However, note that the incoming bitstream still has to be decoded completely because it has to be retained for referencing future ideal pictures. When the total number of slice groups in the incoming quadrants is greater than 4 added to the number of incoming quadrants coded using only I-slices, the above simplification will not apply to some or all such quadrants because slice groups in some or all quadrants will need to be merged to keep the total number of slice groups within the stitched picture at or below 8 in order to conform to the Baseline profile.

C. Error Concealment Procedure Used in the Decoder for H.264 Stitching in a General Stitching Scenario

In the detailed description of H.264 stitching in a general scenario, it was indicated that it is the individual decoder's responsibility to make a decoded frame available and indicate as such to the stitching operation. The details of error concealment used by the decoder described next. This procedures assumes that incoming video streams are packetized using Real Time Protocol (RTP) in conjunction with User Datagram Protocol (UDP) and Internet Protocol (EP), and that the packets are sent over an IP-based LAN build over Ethernet (MTU=1500 bytes). Furthermore, a packet received at the decoder is assumed to be correct and without any bit errors. This assumes that any packet corrupted during transmission will be detected and dropped by an underlying network mechanism. Therefore, the error is entirely in the form of packet losses.

In order to come up with effective error concealment strategies, it is important to understand the different types of packetization that are performed by the H.264 encoders/endpoints. The different scenarios of packetization are listed below (note: a slice is a NAL unit):

1. Slice→1 Packet

This type of packetization is commonly used for a P-slice of a picture. Typically, for small picture resolutions such as QCEF and relatively error-free transmission environments, only one slice is used per picture and therefore a packet contains an entire picture.

According to RTP payload format for H.264, this is “single NAL unit packet” because a packet contains a single whole NAL unit in the payload.

2. Multiple Slices→>1 Packet

This is used to pack (some or all) the slices in a picture in to a packet. Since pictures are generated at different time instants, only slices from the same picture are put in to a packet. Trying to put slices from more than one picture in to a packet will introduce delay which is undesirable in applications such as videoconferencing.

According to RTP payload format for H.264, this is “single-time aggregation packet”.

3. Slice→Multiple Packets

This happens when a single slice is fragmented over multiple packets. It is typically used to pack an I-slice. Coded I-slices are typically large and therefore sit in multiple packets or fragments. It is important to note here that loss of a single packet or fragment means that the entire slice has to be discarded.

According to RTP payload format for H.264, this is “fragmentation unit”.

From the above discussion, it can be summarized that the loss of two types of video coding units has to be dealt with in error concealment at the decoder, namely,
1. Slice
2. Picture

An important aspect of error concealment is that it is important to know whether the lost slice/picture was intra-coded or inter-coded. Intra-coding is typically employed by the encoder at the beginning of a video sequence, where there is a scene change, or where there is motion that is too fast or non-linear. Inter-coding is performed whenever there is smooth, linear motion between pictures. Spatial concealment is better suited for intra-coded coding units and temporal concealment works better for inter-coded units.

It is important to note the following properties about an RTP stream containing coded video:
1. A packet (or packets) generated out of coding a single video picture is assigned a unique RTP timestamp
2. Every RTP packet has a unique and consecutively ascending sequence number

Using the above, it is easy to group the packets belonging to a particular picture as well as determine which packets got lost (corresponding to missing sequence numbers) during transmission.

Slice loss concealment procedure is described next. Slices can be categorized as I, P, or IDR. An IDR-slice is basically an I-slice that forms a part of an IDR picture. An IDR picture is the first coded picture in a video sequence and has the ability to do an “instantaneous refresh” of the decoder. When transmission errors happen, the encoder and decoder lose synchrony and errors propagate due to motion prediction that is performed between pictures. An IDR-picture is a very potent tool in this scenario since it “resynchronizes” the encoder and the decoder.

In dealing withslices lost, it is assumed that a picture consists of multiple slices and that at least one slice has been received by the decoder (otherwise, the situation is considered as picture loss rather than a slice loss). In order to conceal slice losses effectively, it is important to determine whether the lost slice was an I, P, or IDR slice. A lost slice in a picture is declared to be of type:
1. IDR if it is known that one of the received slices in that picture is IDR.
2. I if one of the received slices in that picture has a slice_type of 7 or 2.
3. P if one of the received slices in that picture has a slice_type of 5 or 0.

A lost slice can be identified as I or P with certainty only if one of the received slices has a slice_type of 7 or 5, respectively. When one of the received slices has a slice_type of 2 or 0, no such assurance exists. However, having said this, it is very likely that in an interactive real-time application such as videoconferencing that all the slices in a picture are of the same slice_type. For e.g., in the case of a scene change, all the slices in the picture will be coded as I-slices. It should be remembered that a P-slice can be composed entirely of I-macroblocks. However, this is a very unlikely event. It is important to note that scattered I-macroblocks in a P-slice are not precluded since this is likely to happen with forced intra-updating of macroblocks (as an error-resilience measure), local characteristics of the picture, etc.

If the lost slice is determined to be an I-slice, spatial concealment can be performed while if it is a P-slice, temporal concealment can beemployed. Spatial concealment referes to the concealment of missing pixel information in a frame using pixel information from within that frame while temporal concealment makes use of pixel information from other frames (typically the reference frames used in inter prediction). The effectiveness of spatial or temporal concealment depends on factors such as:
1. Video content—the amount of motion, type of motion, richness of texture, etc. If there is too much motion between pictures or if the spatial features of the picture are complex, concealment becomes complicated and may require sophisticated resources
2. Slice structure—the organization of macroblocks into slices. The encoder can choose to create slices in such a way as to aid error concealment. For e.g., put scattered macroblocks into a slice so that when a slice is lost, the macroblocks in that slice can be effectively concealed with the received neighbors

The following pseudo-code summarizes the slice concealment methodology:

```
if(Lost slice is IDR-slice or I-slice)
    Initiate a videoFastUpdatePicture command through the H.241
    signaling mechanism
else if(Lost slice is P-slice)
    Initiate temporal concealment procedure
end
```

The above algorithm does not employ any spatial concealment. This is because spatial concealment is most effective only in concealing isolated lost macroblocks. In this scenario, a lost macroblock is surrounded by received neighbors and therefore spatial concealment will yield good results. However, if an entire slice containing multiple macroblocks is lost, spatial concealment typically does not have the desired conditions to produce useful results. Taking into account the relative rareness of I-slices in the context of videoconferencing, it would make sense to solve the problem by requesting an IDR-picture through the H.241 signaling mechanism.

The crux of temporal concealment involves estimating the motion vector and the corresponding reference picture of a lost macroblock from its received neighbors. The estimated information is then used to perform motion compensation in order to obtain the pixel information for the lost macroblock. The reliability of the estimate depends among other things on how many neighbors are available. The estimation process, therefore, can be greatly aided if the encoder pays careful attention to the structuring of the slices in the picture. Details of the implementation of temporal concealment are provided in what follows. While decoding, a macroblock map is maintained and it is updated to indicate that a certain macroblock has been received. Once all of the information for a particular picture has been received, the map indicates the positions of the missing macroblocks. Temporal concealment is then initiated for each of these macroblocks. The temporal concealment technique described here is similar in spirit to the technique proposed in W. Lam, A. Reibman and B. Liu “Recover of Lost or Erroneously Received Motion Vectors”, the teaching of which is incorporated herein by reference.

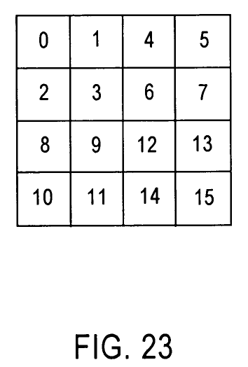

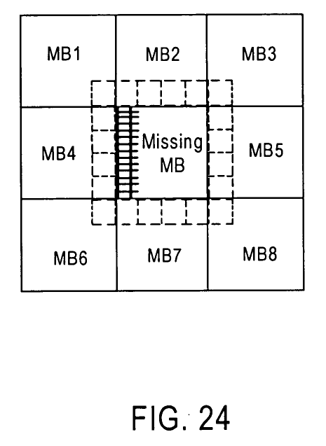

The following discussion explains the procedure of obtaining the motion information of the luma part of a lost macroblock. The chroma portions of the lost macroblock derive their motion information from the luma portion as described in the H.264 standard. FIG. 23 shows the numbering for the 16 blocks arranged in a 4×4 array inside the luma potion of a macroblock. A lost macroblock uses up to 20 4×4 arrays from 8 different neighboring macroblocks for estimating its motion information. A macroblock is used in the estimation only if it has been received, i.e., concealed macroblocks are not used in the estimation procedure. FIG. 24 illustrates the 4×4 block arrays neighbors used in estimating the motion information of a lost macroblock. The neighbors are listed below:
NB 1: Block 15
MB 2: Blocks 10, 11, 14, 15
MB 3: Block 10
MB 4: Blocks 5, 7, 13, 15
MB 5: Blocks 0, 2, 8, 10
MB 6: Block 5
MB 7: Blocks 0, 1, 4, 5
MB 8: Block 0

First, the ref_idx_{—}10 (reference picture) of each available neighbor is inspected and the most commonly occurring ref_idx_{—}10 chosen as the estimated reference picture. Then, from those neighbors whose ref_idx_{—}10 is equal to the estimated value, the median of their motion vectors is found to be the estimated motion vector for the lost macroblock.

Next we consider the picture loss concealment procedure. This deals with the contingency of losing an entire picture or multiple pictures. The best way to conceal the loss of a picture is to copy the pixel information from the temporally previous picture. The loss of pixel information, however, is only one of the many problems resulting from picture loss. In compensating for picture loss, it is important to determine the number of pictures that have been lost in transit at a given time. This information can then be used to shift the multi-picture reference buffer appropriately so that subsequent pictures do not incorrectly reference pictures in this buffer. When gaps in frame numbers are not allowed in the video stream, it is possible to determine from the frame_num of the current slice and that of the previously received slice as to how many frames/pictures were lost in transit. However, if gaps in frame num are in fact allowed, then even with the knowledge of the exact number of packets lost (through RTP sequence numbering), it is not possible to determine the number of pictures lost. Another important piece of information that is lost with a picture is whether it was a short-term reference, long-term reference, or a non-reference picture. A wrong guess of any of the parameters mentioned before may cause serious non-compliance problems to the decoder at some later stage of decoding.

The following approach is taken to combat loss of picture or pictures:
1. The number of pictures lost is determined
2. The pixel information of each lost picture is copied from the temporally previous picture
3. Each lost picture is placed in the ShortTermReferencePicture buffer
4. If non-compliance is detected in the stream, an H.241 command called videoFastUpdatePicture is initiated in order to request an IDR-picture

By placing a lost picture in the ShortTermReferencePicture buffer, a sliding window process is assumed as default in the context of decoded reference picture marking. In case the lost picture had carried MMCO commands, the decoder will likely face a non-compliance problem at some point of time. Requesting an IDR-picture in such a scenario is an elegant and effective solution. Receiving the IDR-picture clears all the reference buffers in the decoder and re-synchronizes it with the encoder.

The following is a list of conditions under which an IDR-picture (accompanied by appropriate parameter sets) is requested by initiating a videoFastUpdatePicture command through the H.241 signaling mechanism.
1. Loss of sequence parameter set or picture parameter set
2. Loss of an IDR-slice
3. Loss of an I-slice (in a non-IDR picture)
4. Detection of non-compliance in the incoming stream—This essentially happens if an entire picture with MMCO commands is lost in transit. This leads to non-compliance of the stream being detected by the decoder at some later stage of decoding
5. Gaps in frame num are allowed in the incoming stream and packet loss is detected
   III. H.263 Drift-Free Hybrid Approach to Video Stitching

Another embodiment of the present invention applies the drift-free hybrid approach to video stitching to H.263 encoded video images. In this embodiment, four QCIF H.263 bitstreams are to be stitched into an H.263 CIF bitstream. Each individual incoming H.263 bitstream is allowed to use any combination of Annexes among the H.263 Annexes D, E, F, I, J, K, R, S, T, and U, independently of the other incoming H.263 bitstreams, but none of the incoming bitstreams may use PB frames (i.e. Annex G is not allowed). Finally, the stitched bitstream will be compliant to the H.263 standard without any Annexes. This feature is desirable so that all H.263 receivers will be able to decode the stitched bitstream.

The stitching procedure proceeds according to the general steps outlined above. First decode the QCIF frames from each of the four incoming H.263 bitstreams. Form the ideal stitched video picture by spatially composing the decoded QCIF pictures. Next, store the following information for each of the four decoded QCIF frames:
1. Store the value of the quantization parameter QUANT used for each macroblock.

Note that this is the actual quantization parameter that was used to decode the macroblock, and not the differential value given by the syntax element DQUANT. If the COD for the given macroblock is 1 and the macroblock is the first macroblock of the picture or if it is the first macroblock of the GOB (if GOB header was present), then the quantization parameter stored is the value of PQUANT or GQUANT in the picture or GOB header respectively. If the COD for the given macroblock is 1 and the macroblock is not the first macroblock of the picture or of the GOB (if GOB header was present), then the QUANT stored for this macroblock is equal to that of the previous macroblock in raster scanning order.
2. Store the macroblock type value for each macroblock. The macroblock type can take one of the following values: INTER (value=0), INTER+Q (value=1), INTER4V (value=2), INTRA (value=3), INTRA+Q (value=4) and INTER4V+Q (value=5). If the COD for a given macroblock is 1, then the value of macroblock type stored is INTER (value=0).
3. For each macroblock for which the stored macroblock type is either INTER, or INTER+Q, store the actual luma motion vector used for the macroblock. Note that the value stored is the actual luma motion vector used by the decoder for motion compensation and not the differential motion vector information MVD. The actual luma motion vector is formed by adding the motion vector predictor to the MVD according to the process defined in sub clause 6.1.1 of the H.263 standard. If the stored macroblock type is either INTER4V or INTER4V+Q, then store the median of the four luma motion vectors used for this macroblock. Note that the stored macroblock type is INTER4V or INTER4V+Q if the incoming bitstream used Annex F of H.263. Again, the four actual luma motion vectors are used in this case. If the COD for the given macroblock is 1, then the luma motion vector stored is (0,0).

The next step is to form the stitched predicted blocks. For each macroblock for which the stored macroblock type is either INTER or INTER+Q or INTER4V or INTER4V+Q, motion compensation is carried out using bilinear interpolation as defined in sub clause 6.1.2 of the H.263 standard to form the prediction for the given macroblock. The motion compensation is performed on the actual stitched video sequence and not on the ideal stitched video sequence. Once the stitched predictor has been determined, the stitched raw residual and the stitched bitstream may be formed. For each macroblock in raster scanning order, the stitched raw residual is calculated as follows: For each macroblock, if the stored macroblock type is either INTRA or INTRA+Q, the stitched raw residual is formed by simply copying the co-located macroblock (i.e. having the same macroblock address) in the ideal stitched video picture; Otherwise, if the stored macroblock type is either INTER or INTER+Q or INTER4V or INTER4V+Q, then the stitched raw residual is formed by subtracting the stitched predictor from the co-located macroblock in the ideal stitched video picture.

The differential quantization parameter DQUANT for the given macroblock (except when the macroblock is the first macroblock in the picture) is formed by subtracting the QUANT value of the previous macroblock in raster scanning order (with respect to CIF picture resolution) from the QUANT of the given macroblock, and then clipping the result to the range {−2, −1, 0, 1, 2}. If this DQUANT is not 0, and the stored macroblock type is INTRA (value=3), the macroblock type must be changed to INTRA+Q (value=4). Similarly, if this DQUANT is not 0, and the stored macroblock type is INTER (value=0) or INTER4V (value=2), the macroblock type must be changed to INTER+Q (value=1). The stitched raw residual is then forward discrete cosine transformed (DCT) according to the process defined by Step A.2 in Annex A of H.263, and forward quantized using a quantization parameter obtained by adding the DQUANT set above to the QUANT of the previous macroblock in raster scanning order in the CIF picture (Note that this quantization parameter is guaranteed to be less than or equal to 31 and greater than or equal to 1). The QUANT value of the first macroblock in the picture is assigned to the PQUANT syntax element in the picture header. The result is then de-quantized and inverse transformed, and then added to stitched predicted blocks to produce the stitched reconstructed blocks. These stitched reconstructed blocks finally form the stitched video picture that will be used as a reference while stitching the subsequent picture.

Next a six-bit coded block pattern is computed for the given macroblock. The Nth bit of the six-bit coded block pattern will be 1 if the corresponding block (after forward transform and quantization in the above step) in the macroblock has at least one non-INTRADC coefficient (N=5 and 6 represent chroma blocks, while N=1,2,3,4 represent the luma blocks). The CBPC is set to the first two bits of the coded block pattern and CBPY is set to the last four bits of the coded block pattern. The value of COD for the given macroblock is set to 1 if all of these four conditions are satisfied: CBPC is 0, CBPY is 0, the DQUANT as set above is 0, and the luma motion vector is (0, 0). Otherwise, set COD to 0, and conditionally modify the macroblock type as follows: If the macroblock type is either INTER+Q (value=1), or INTER4V (value=2), or INTER4V+Q (value=3), and if DQUANT is set above to 0, then the macroblock type must be changed to INTER (value=0). If the macroblock type is INTRA+Q (value=4), and if DQUANT is set above to 0, then the macroblock type must be changed to INTRA (value=3). Note that the macroblock type for the first macroblock in the picture is always set to either INTRA or INTER.

If the COD of the given macroblock is set as 0, the differential motion vector data MVD is formed by first forming the motion predictor for the given macroblock using the luma motion vectors of its neighbors, according to the process defined in 6.1.1 of H.263, assuming that the header of the current GOB is empty.

The stitched bitstream is formed as follows: At the picture layer, the optional PLUSPTYPE is never used (i.e. Bits 6-8 in PTYPE are never set to “111”). These bits are set based on the resolution of the stitched output, e.g., if stitched picture resolution is CIF, then bits 6-8 are ‘011’. Bit 9 of PTYPE is set to “0” INTRA (I-picture) if this is the very first output stitched picture, otherwise it is set to “1” INTER (P-picture). CPM is set to off. No annexes are enabled. The GOB layer is coded without GOB headers. In the macroblock layer the syntax element COD is first coded. If COD=O, the syntax elements MCBPC, CBPY, DQUANT, MVD (which have been set earlier) are entropy encoded according to Tables 7, 8, 9, 12, 13 and 14 in the H.263 standard. In the block layer, if COD=O, entropy encode the forward transformed and quantized residual blocks, using Tables 15, 16 and 17 in the H.263 standard, based on coded block pattern information. Finally, the forward transformed and quantized residual coefficients are dequantized and inverse transformed, the result is added to the stitched predicted block to obtain the stitched reconstructed block, thereby completing the loop of FIG. 17.

It is pointed out here that for H.263 stitching in a general scenario where incoming bitstreams are not synchronized with respect to each other and are transmitted over error-prone conditions, techniques similar to those described later for H.264 can be employed. In fact, the techniques for H.263 will be somewhat simpler. For example, there is no concept of coding reference picture index in H.263 since always the temporally previous picture is used in H.263. The equivalent of MISSING_P_SLICES_WITH_P_SKIP_MBS (see later) can be devised by simply setting COD to 1 in macroblocks of an entire quadrant. Also, like in H.264, the error concealment is the responsibility of the H.263 decoder, and an error concealment procedure for H.263 decoder is described separately towards the end of this invention.

IV. Error Concealment for H.263 Decoder

The error concealment for H.263 decoder described here starts with similar assumptions as in H.264. As in the case of H.264, it is important to note the following properties about an RTP stream containing coded video:
1. A packet (or packets) generated out of coding a single video picture is assigned a unique RTP timestamp
2. Every RTP packet has a unique and consecutively ascending sequence number

Using the above, it is easy to group the packets belonging to a particular picture as well as determine which packets got lost (corresponding to missing sequence numbers) during transmission.

In order to come up with effective error concealment strategies, it is important to understand the different types of RTP packetization that is expected to be performed by the H.263 encoders/endpoints. For videoconferencing applications that utilize a H.263 baseline video codec, the RTP packetization is carried out in accordance with internet engineering tak force, RFC 2190: RTP payload format for H.263 video streams, September 1997, in either mode A or mode B (as described earlier).

For mode A, the packetization is carried out on GOB or picture boundaries. The use of GOB headers or sync markers is highly recommended when mode A packetization is used. The primary advantages in this mode is the low overhead of 4 bytes per RTP packet and the simplicity of RTP encapsulation of the payload. The disadvantages are the granularity of the payload size that can be accommodated (since the smallest payload is the compressed data for an entire GOB) and poor error resiliency. If GOB headers are used, we can identify those GOBs which the RTP packet contains information about and thereby infer the GOBs for which no RTP packets have been received. For the MBs that correspond to the missing GOBs, temporal or spatial error concealment is applied. The GOB headers also help initialize the QUANT and MV information for the first macroblock in the RTP packet. In the absence of GOB headers, only picture or frame error concealment is possible.

For mode B, the packetization is carried out on MB boundaries. As a result, the payload can range from the compressed data of a single MB to the compressed data of an entire picture. An overhead of 8 bytes per RTP packet is used to provide for the starting GOB and MB address of the first MB in the RTP packet as well as its initial QUANT and MV data. This makes it easier to recover from missing RTP packets. The MBs corresponding to these missing RTP packets are inferred and temporal or spatial error concealment is applied. Note that picture or frame error concealment is needed only if an entire picture or frame is lost irrespective of whether GOB headers or sync markers are used.

In the case of H.263, there is no distinction between frame or picture loss error concealment and treatment of missing access units or pictures due to asynchronous reception of RTP packets. In this respect, H.263 and H.264 are fundamentally different. This fundamental difference is due to the multiple reference pictures in the reference picture list utilized by H.264 while the H.263 baseline's reference picture is confined to its immediate predecessor. A dummy P picture all of whose MBs have COD=1 is used instead of the “missing” frame for purposes of frame error concealment.

Temporal error concealment for missing MBs is carried out by setting COD to 0, mb_type to INTER (and hence DQUUANT to 0), and all coded block patterns CBPC, CBPY, and CBP to 0. The differential motion vectors in both direction are also set to 0. This ensures that the missing MBs are reconstructed with the best estimate of QUANT and MV that H.263 can provide. It is important to note, however, that in many cases one can do better than using the MV and QUANT information of all the MB's neighbors as in FIG. 24.

As in H.264, we have not employed any spatial concealment in H.263. The reason for this is the same as that in H.264. Spatial concealment is most effective only in concealing isolated lost macroblocks when it is surrounded by received neighbors. However, in situations where an entire RTP packet containing multiple macroblocks is lost, spatial concealment typically the desired conditions to produce useful results using spatial concealment are not present.

In a few instances, we can neither apply picture/frame error concealment nor temporal/spatial error concealment. These instances occur when we have parts or an entire I picture is missing. In such cases, a videoFastUpdatePicture command is initiated using H.245 signaling to request an I-frame to refresh the decoder.

V. Alternative Practical Approaches for H.263 Stitching

Video stitching of H.263 video streams using the drift-free hybrid approach has been described above. The present invention further encompasses a number of the alternative practical approaches to video stitching for combining H.263video sequences. Three such approaches are:
1. Video stitching employing H.263Annex K
2. Nearly compressed domain video stitching
3. Stitching using H.263 payload headers in RTP packets.

A. Alternative Practical Approach for H.263 Stitching Employing Annex K

This method employs Annex K (with the Rectangular Slice submode) of the H.263 standard. Each component picture is assumed to have rectangular slices numbered from 0 to [9k-1] with widths 11i ( i.e., the slice width indication SWI is [11i-1]) where k is 1, 2, or 2 and i is 1, 2, or 4 corresponding to QCIF, CIF, or 4CIF component picture resolution, respectively. The MBA numbering for these slices will be 11ij where j is the slice number.

The stitching procedure is as follows:
1. Modify the OPPTYPE bits 1-3 in the picture header of the stitched bitstream to reflect the quadrupled size of the picture. Apart from this, the picture header of the stitched stream is exactly the same as each of the component streams
2. Modify the MBA field in each slice as:
   a. MBA of Slice j in picture A is changed from 11ij to [22ij]
   b. MBA of Slice j in picture B is changed from 11ij to [22ij+11i]
   c. MBA of Slice j in picture C is changed from 11ij to [22(j+[9k-1]+1)]
   d. MBA of Slice j in picture D is changed from 11ij to [22(j+[9k-1]+1)+11i]
3. Arrange the slices from the component pictures into the stitched bitstream as:
   A-0, B-0, A-1, B-1, . . . , A-[9k-1], B-[9k-1], C-0, D-0, C-1, D-1, . . . , C-[9k-1], D-[9k-1]
      where the notation is (Picture #-Slice #)

Alternatively, invoke the Arbitrary Slice Ordering submode of Annex K (by modifying the SSS field of the stitched picture to “11”) and arrange the slices in any order
4. The PSTUF and SSTUTF fields may have to be modified to ensure byte-alignment of the start codes PSC and SSC, respectively

For the sake of simplicity of explanation, the stitching procedure assumed the width of a slice to be equal to that of a GOB as well as the same number of slices in each component picture. Although such assumptions would make the stitching procedure at the MCU uncomplicated, stitching can still be accomplished without these assumptions.

Note that this stitching approach is quite simple but may not be used when Annex D, F, or J (or a combination of these) is employed except when Annex R is also employed. Annexes D, F, and J cause a problem because they allow the motion vectors to extend beyond the boundaries of the picture. Annex J causes an additional problem because the deblocking filter operates across block boundaries and does not respect slice boundaries. Annex R solves these problems by extrapolating the appropriate slice in the reference picture to form predictions of the pixels which reference the out-of-bounds region and restricting the deblocking filter operation across slice boundaries.

B. Nearly Compressed Domain Approach for H.263 Stitching

This approach is performed in the compressed domain and entails the following main steps:
1. Parsing (VLC decoding) the individual QCIF bitstreams
2. Differential motion vector modification (where necessary)
3. DQUANT modification (where necessary)
4. DCT coefficient re-quantization and re-encoding (where necessary- about 1% of the time)
5. Construction of stitched CIF bitstream

This approach is meant for the baseline profile of H.263, which does not include any of the optional coding tools specified in the annexes. Typically, in continuous presence multipoint calls, H.263 annexes are not employed in the interest of inter-operability. In any event, since the MCU is the entity that negotiates call capabilities with the endpoint appliance, it can ensure that no annexes or optional modes are used.

The detailed procedure isas follows. As in FIG. 1, the four QCIF pictures to be stitched are denoted as A, B, C, and D. Each QCIF picture has GOBs numbered from 0 to i where i is 8. The procedure for stitching is as given below:
1. Modify the PTYPE bits 6-8 in the picture header of the stitched CIF bitstream to reflect the quadrupled size of the picture. Apart from this, the picture header of the stitched CIF stream is exactly the same as each of the QCIF streams.
2. Rearrange the GOB data into the stitched bitstream as
   A-0, B-0, A-1, B-1 , . . . , A-i, B-i, C-0, D-0, C-1, D-1, . . . , C-i, D-i
      where the notation is (Picture #-GOB #).
      Note that (A-0, B-0) is GOB 0, (A-1, B-1) is GOB 1, . . . , and (C-i, D-i) is the final GOB in the stitched picture.
3. Each GOB in the stitched CIF bitstream shall have a header. Toward achieving this—
   a) The GOB headers (if they exist) of the left-side QCIF pictures (A and C) are incorporated into the stitched CIF picture after suitable modification to the GOB number (the 5-bit GN field) and GFID (2-bit). Appropriate GSTUF has to be inserted in each GOB header if GBSC has to be byte-aligned.
   b) If any GOB headers are missing in the left-side QCIF pictures (A and C), suitable GOB headers are created and placed in the stitched bitstream.
   c) The GOB headers of the right-side QCIF pictures (B and D) are discarded.
4. Modify the differential motion vector (MVD) fields in the stitched picture where it is necessary.
5. Modify the macroblock differential quantizer (DQUANT) fields in the stitched picture where it is necessary.
6. Re-quantize and VLC encode DCT blocks wherever necessary.
7. The PSTUF field may have to be modified in order to ensure that PSC remains byte aligned.

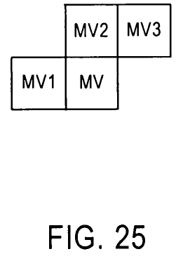

The following procedure is employed to avoid incorrect motion vector prediction in the stitched picture. According to the H.263 standard, the motion vectors of macroblocks are coded in an efficient differential form. This motion vector differential, MVD, is computed as: MVD=MV−MVpred, where MVpred is the motion vector predictor for the motion vector MV. MVpred is formed from the motion vectors of the macroblocks neighboring the current macroblock. For example, MVpred=Median (MV1, MV2, MV3), where MV1 (left macroblock), MV2 (top macroblock), MV3 (top right macroblock) are the three candidate predictors in the causal neighborhood of MV (see FIG. 25). In the special cases at the borders of the current GOB or picture, the following decision rules are applied (in increasing order) to determine MV1, MV2, and MV3:
1. When the corresponding macroblock was coded in INTRA mode or was not coded, the candidate predictor is set to zero.
2. The candidate predictor MV1 is set to zero if the corresponding macroblock is outside the picture.
3. The candidate predictors MV2 and MV3 are set to MV1 if the corresponding macroblocks are outside the picture (at the top) or outside the GOB (at the top) if the GOB header of the current GOB is non-empty.
4. The candidate predictor MV3 is set to zero if the corresponding macroblock is outside the picture (at the right side).

The above prediction process causes trouble for the stitching procedure at some of the component picture boundaries, i.e., wherever the component pictures meet in the stitched picture. These arise because component picture boundaries are not considered as picture boundaries by the decoder (which has no conception of the stitching that took place at the MCU). Next, the component pictures may skip some GOB headers, but the existence of such GOB headers impacts the prediction process. These factors cause the encoder and the decoder to lose synchronization with respect to the motion vector prediction. Accordingly, errors will propagate to other macroblocks through motion prediction in subsequent pictures.

To solve the problem of incorrect motion vector prediction in the stitched picture, the following steps have to performed during stitching:
1. For the first pair of QCIF GOBs to be merged, only the MVD of the leftmost macroblock of the right-side QCIF GOB is re-computed and re-encoded.
2. For the other 17 pairs of QCIF GOBs to be merged:
   a. if (left-side QCIF GOB has a header)
      then No MVD needs to be modified
      else Re-compute and re-encode the MVDs of all the 1 1 macroblocks on left-side GOB.
   b. if (right-side QCIF GOB has a header)
      then Re-compute and re-encode only the MVD of the left-most macroblock
      else Re-compute and re-encode MVDs of all the 11 macroblocks on right-side GOB.

The following procedure is used to avoid the use of the incorrect quantizer in the stitched picture. In the H.263 standard, every picture has a PQUANT (picture-level quantizer), GQUANT (GOB-level quantizer), and a DQUANT (macroblock-level quantizer). PQUANT (mandatory 5-bit field in the picture header) and GQUANT (mandatory 5-bit field in the GOB header) can take on values between 1 and 31 (both values inclusive) while DQUANT (2-bit field present in the macroblock depending on the macroblock type) can take on only 1 of 4 different values {−2, −1, 1, 2}. DQUANT is essentially a differential quantizer in the sense that it changes the current value of QUANT by the number it specifies. When encoding or decoding a macroblock, the QUANT value set via any of these three parameters will be used. It is important to note that while the picture header is mandatory, the GOB header may or may not be present in a GOB. GQUANT and DQUANT are made available in the standard so that flexible bitrate control may be achieved by controlling these parameters in some desired way.

During stitching, the three quantization parameters have to be handled carefully at the boundaries of the left-side and right-side QCWF GOBs. Without this procedure, the QUANT value used for a macroblock while decoding it may be incorrect starting with the left-most macroblock of the right-side QCIF GOB.

The algorithm outlined below can be used to solve the problem of using incorrect quantizer in the stitched picture. Since each GOB in the stitched CIF picture shall have a header (and therefore a GQUANT), the DQUANT adjustment can be done for each pair of QCIF GOBs separately. The parameter i denotes the macroblock index taking on values from 0 through 11 corresponding to the right-most macroblock of the left-side QCWF GOB through to the last macroblock of the right-side QCIF GOB. The parameters MB[i], quant[i], and dquant[i] denote the data, QUANT, and DQUANT corresponding to i th macroblock, respectively. For each of the 18 pairs of QCIF GOBs, do the following on the right-side GOB macroblocks:

```
for ( i = 1; i ≦ 11; i ++ )
    if ( (quant[i] − quant[i−1] ) > 2 ) then
        dquant[i] = 2
        quant[i] = quant[i−1] + 2
        re-quantize(MB[i]) with quant[i]
        re-encode(MB[i])
    else if ((quant[i] − quant[i−1]) < −2 ) then
        dquant[i] = −2
        quant[i] = quant[i−1] − 2
        re-quantize(MB[i]) with quant[i]
        re-encode(MB[i])
    else if ( quant[i] = quant[i−1] ) then
        exit
    else dquant[i] = quant[i] − quant[i−1]
    end if
end for
```

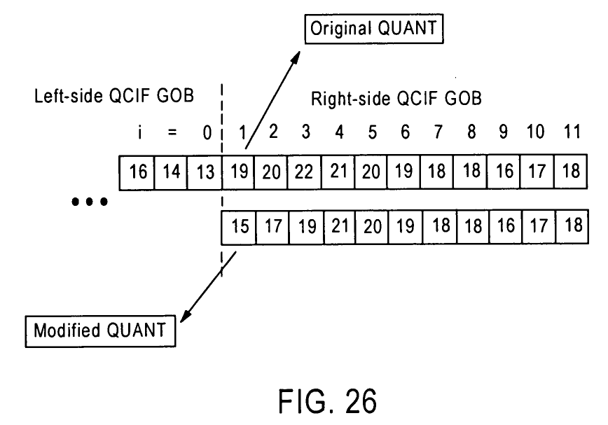

An example of using the above algorithm is shown in FIG. 26 for a pair of QCIF GOBs. As can be inferred from the algorithm, when the DQUANT of a particular macroblock is unable to handle the difference between the current and previous QUANT, there is a need to re-quantize and re-encode (VLC encode) the macroblock. This will affect the quality as well as the number of bits consumed by the stitched picture. However, this scenario of the overloading of DQUANT happens very rarely while stitching typical videoconferencing content and therefore the qualitylbitrate impact will be minimal. It is important to remember that the algorithm pertains only to the right-side QCIF GOBs and that the left-side QCIF GOBs remain unaffected.

In P-pictures, many P-macroblocks do not carry any data. This is indicated by the COD field in the macroblock being set to 1. When such macroblocks lie near the boundary between the left- and the right-side QCIF GOBs, it is possible to take advantage of them by re-encoding them as macroblocks with data, i.e., change COD field to 0, which leads to the following further additions to the macroblock:
1. A suitable DQUANT to indicate the difference between the desired quant[i] and the previous quant[i-1]
2. Coded block pattern set to 0 for both luminance and chrominance (since the re-encoded MB will be of type INTER+Q) to indicate no coded block data
3. Suitable differential motion vector such that the motion vector turns out to be zero

Note that, we can do this for such macroblocks regardless of whether they lie on the left side or right side of the boundary. Furthermore, if there are consecutive such macroblocks on either side of the boundary, then we can take advantage of the entire string of such macroblocks. Finally, we note that for some P-macroblocks, we may have the COD field set to 0 but there may be no transform coefficient data, as indicated by a zero Coded Block Pattern for both luminance and chrominance. We can take advantage of macroblocks of this type in the same manner, if they lie near the boundary except that we retain the original value of the differential motion vector in the last step instead of setting it to 0.

One way to improve the above algorithm is to have a process to decide whether to re-quantize and re-encode macroblocks in the left-side or the right-side GOB instead of always choosing to do the macroblocks in the right-side GOB. When the QUANT values used on either side of the boundary between the left and right side QCEF GOBs differ by a large amount, then the loss in quality due to the re-quantization process can be noticeable. Under such conditions, the following approach is used to mitigate the loss in quality:
1. After stitching a pair of QCIF GOBs, assess the quality of the stitching based on
   a. the difference between the original QUANT and the stitched QUANT in all the stitched macroblocks (only for COD=0 stitched macroblocks)
   b. number of times the transform residual coefficients have to be re-encoded in all the stitched macroblocks
2. If the quality is below a chosen threshold, repeat the stitching of the pair of QCIF GOBs but distributing the re-quantization and re-encoding on either side of the boundary.

This approach increases the complexity of the algorithm by a negligible amount since we can compute this measure of quality of stitching after the pair of QCIF GOBs have been decoded but prior to its stitching. Hence, the decision to distribute the re-quantization and re-encoding on either side of the boundary of the QCIF GOBs can be made prior to its stitching. Finally, this situation happens very rarely (less than 1% of the time). For all of these reasons, this approach has been incorporated into the stitching algorithm.

The basic idea of the simplified compressed domain H.263 stitching, consisting of the three main steps (i.e. parsing of the individual QCIF bitstream, differential motion vector modification and DQUANT modification), has been described in D. J. Shiu, C. C. Ho, and J. C. Wu, “A DCT-Domain H.263 Based Video Combiner for multipoint Continuous Presence Video Conferencing”, Proc. IEEE Conf. Multimedia Computing and Systems (ICMCS 1999), Vol. 2 pp. 77-81, Florence, Italy June 1999, the teaching of which is incorporated herein by reference. However, the specific details for DQUANT modification as proposed here are unique to the present invention.

C Detailed Description of Alternative Practical Approach for H.263 Stitching Using H.263 Payload Header in RTP Packet

In the case of videoconferencing over IP networks, the audio and video information is transported using the real time protocol (RTP). Once the appliance has encoded the input video frame into H.263 bitstream, it is packaged as RTP packets according to RFC 2190. Each such RTP packet consists of a header and a payload. The RTP payload contains the H.263 payload header, and the H.263 bitstream payload.

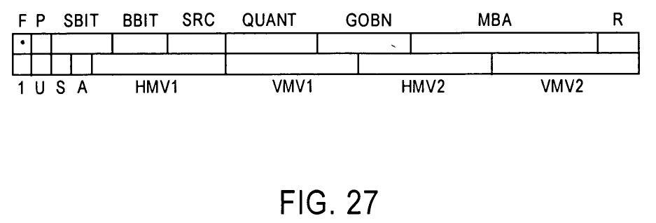

Three formats, Mode A, ModeB and Mode C, are defined for the H.263 payload header:

| | |
|---|---|
| Mode A: | In this mode, an H.263 bitstream will be packetized on |
| | a GOB boundary or a picture boundary. Mode A packets |
| | always start with the H.263 picture start code or a GOB |
| | but do not necessarily contain complete GOBs. |
| Mode B: | In this mode, an H.263 bitstream can be fragmented |
| | at MB boundaries. Whenever a packet starts at a MB |
| | boundary, this mode shall be used as long as the |
| | PB-frames option is not used during H.263 encoding. |
| | The structure of the H.263 payload |
| | header for this mode is shown in FIG. 27. |
| | The various fields in the structure are |
| | described in what follows: |
| | F: 1 bit |
| | The flag bit indicates the mode of the payload header. |
| | F = 0 - mode A |
| | F = 1 - mode B or C |
| | P: 1 bit |
| | P = 0 - mode B |
| | P = 1 - mode C |
| | SBIT: 3 bits |
| | Start bit position specifies the number of most significant bits |
| | that shall be ignored in the first data byte. |
| | EBIT: 3 bits |
| | Start bit position specifies the number of least significant bits |
| | that shall be ignored in the last data byte. |
| | SRC: 3 bits |
| | Specifies the source format, i.e., resolution |
| | of the current picture |
| | QUANT: 5 bits |
| | Quantization value for the first MB coded at the start of the |
| | packet. Set to zero if packet begins with GOB header. |
| | GOBN: 5 bits |
| | GOB number in effect at the start of the packet. |
| | MBA: 9 bits |
| | The address of the first MB (within the GOB) in the packet. |
| | R: 2 bits |
| | Reserved and must be set to zero. |
| | I: 1 bit |
| | Picture coding type. |
| | I = 0 - Intra picture |
| | I = 1 - Inter picture |
| | U: 1 bit |
| | U = 1 - Unrestricted motion vector mode used |
| | U = 0 - Otherwise |
| | S: 1 bit |
| | S = 1 - Syntax-based arithmetic coding mode used |
| | S = 0 - Otherwise |
| | A: 1 bit |
| | A = 1 - Advanced prediction mode used |
| | A = 0 - Otherwise |
| | HMV1, VMV1: 7 bits each |
| | Horizontal and vertical motion vector predictors for the first |
| | MB in the packet. When four motion vectors are used for |
| | the MB, these refer to the predictors for the block number |
| | HMV2, VMV2: 7 bits each |
| | Horizontal and vertical motion vector predictors for block |
| | number 3 in the first MB in the packet when four motion |
| | vectors are used for the MB. |
| Mode C: | This mode is essentially the same as mode B |
| | except that this mode is applicable whenever the PB-frames |
| | option is used in the H.263 encoding process. |

First, it has to be determined as to which of the three modes is suitable for packetization of the stitched bitstream. Since the PB-frames option is not expected to be used in videoconferencing for delay reasons, mode C can be eliminated as a candidate. In order to figure out whether mode A or mode B is suitable, the discussion of H.263 stitching from the previous section has to be recalled. During stitching, each pair of GOBs from the two QCIF quadrants is merged into a single CIF GOB. Two issues arise out of such a merging process:
a. Incorrect motion vector prediction in the stitched picture
b. Incorrect quantizer use in the stitched picture

The incorrect motion vector prediction problem can be solved rather easily by re-computing the correct motion vector predictors (in the context of the CIF picture) and thereafter the correct differential motion vectors to be coded into the stitched bitstream. The incorrect quantizer use problem is unfortunately not as easy to solve. The GOB merging process leads to DQUANT overloading in some rare cases thereby requiring re-quantization and re-encoding of the affected macroblocks. This may lead to a loss of quality (however small) in the stitched picture which is undesirable. This problem can be prevented only if DQUANT overloading can somehow be avoided during the process of merging the QCIF GOBs. One solution to this problem would be to figure out a way of setting QUANT to the desired value right before the start of the right-side QCIF GOB in the stitched bitstream. However, since the right-side QCIF GOB is no longer a GOB in the CIF picture, a GOB header cannot be inserted to provide the necessary QUANT value through GQUANT. This is exactly where mode B of RTP packetization, as described above, can be helpful. At the output of the stitcher, the two QCIF GOBs corresponding to a single CIF GOB can be packaged into different RTP packets. Then, the 5-bit QUANT field present in the H.263 payload header in mode B RTP packets (but not in mode A packets) can be used to set the desired QUANT value (the QUANT seen in the context of the QCIF picture) for the first MB in the packet containing the right-side QCIF GOB. This will ensure that there is no overloading of DQUANT and therefore no loss in picture quality.

One potential problem with the proposed lossless stitching technique described above is the following. The QUANT assigned to the first MB of the right-side QCIF GOB through the H.263 payload header in the RTP packet will not agree with the QUANT computed by the CIF decoder based on the QUANT of the previous MB and the DQUANT of the current MB (if the QUANT values did agree, there would be no need to insert a QUANT through the H.263 payload header). In this scenario, it is unclear as to which QUANT value will be picked by the decoder for the MB in question. The answer to this question probably depends on the strategy used by the decoder in a particular videoconferencing appliance.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of generating a stitched video frame in a sequence of stitched video frames;
decoding a plurality of video bitstreams to produce a plurality of pixel-domain pictures;
spatially composing said plurality of pixel domain pictures to create a single ideal stitched video frame;
storing prediction information from said plurality of decoded video bitstreams;
forming a stitched predictor by performing temporal prediction for inter-coded portions of the stitched video frame based on the stored prediction information and a retained reference frame in said sequence of stitched video frames and performing spatial prediction using retained intra-prediction information on the stitched video frame;
forming a stitched raw residual by subtracting the stitched predictor for a portion of the stitched video frame from a corresponding portion of the ideal stitched video frame;
forward transforming and quantizing the stitched raw residual; and
entropy encoding the forward transformed and quantized stitched raw residual.

2. The method of claim 1 further including the steps of transmitting an output stitched video bitstream representing the stitched video frame to a decoder.

3. The method of claim 1 further including the steps of de-quantizing and reverse transforming the forward transformed and quantized stitched raw residual block to form a stitched decoded residual block; and
adding the stitched decoded residual block to the stitched predictor to form a reconstructed block of pixels in the stitched video frame in the sequence of stitched video frames.

4. The method of claim 1 wherein said plurality of decoded video bitstreams comprise QCWF video frames, and said ideal stitched video frame comprises a CIF video frame.

5. The method of claim 1 wherein said plurality of decoded video bitstreams comprise CIF video frames, and said ideal stitched video frame comprises a 4CIF video frame.

6. The method of claim 2 wherein said stitched video bitstream conforms to a H.263 standard.

7. The method of claim 2 wherein said stitched video bitstream conforms to a H.264 standard.

8. The method of claim 1 wherein the said plurality of video bitstreams and the said stitched bitstream conform to a mixed set of video coding standards.

9. The method of claim 8 wherein the mixed set of video coding standards is a subset or the whole of {H.261, H.263, H.264}.

10. A hybrid drift free method of performing video stitching comprising:
spatially an ideal stitched video sequence in the pixel domain;
predicting elements of a current frame in a stitched video sequence; and
generating the current frame in the stitched video sequence based on the predicted elements of the current frame and the differences between the predicted elements of the current frame and corresponding elements of a corresponding frame of the ideal stitched video sequence.

11. The method of claim 10 further comprising the steps of:
encoding a forward transformed and quantized stitched raw residual element representing the difference between a predicted element of the current frame and a corresponding element of a corresponding frame of the ideal stitched video sequence; and
transmitting the encoded stitched forward transformed and quantized stitched raw residual element as part of a stitched video sequence.

12. The method of claim 10 wherein the step of generating the current frame in the stitched video sequence comprises decoding the stitched raw residual element to form a stitched decoded residual element and adding the stitched decoded residual element to the predicted element of the current frame.

13. The method of claim 10 wherein the step of predicting elements of the current frame in the video sequence comprises:
decoding a plurality of input video bitstreams;
storing prediction information from said plurality of decoded video bitstreams;
using the stored prediction information along with pixel data from a previous frame in the stitched video sequence to predict elements of the current frame of the stitched video sequence.

14. The method of claim 13 wherein said plurality of input video bitstreams comprises compressed video bitstreams conforming to ITU-T H.263 standard.

15. The method of claim 14 wherein said plurality of input video bitstreams correspond to QCIF resolution.

16. The method of claim 14 wherein said plurality of input video bitstreams correspond to CIF resolution.

17. The method of claim 13 wherein said plurality of input video bitstreams comprise compressed video bitstreams conforming to ITU-T H.264 standard.

18. The method of claim 17 wherein said plurality of input video bitstreams correspond to QCIF resolution.

19. The method of claim 17 wherein said plurality of input video bitstreams correspond to CIF resolution.

20. A method of generating a stitched video sequence comprising:
composing a first stitched video sequence in the pixel domain;
generating a stitched predictor for predicting the pixel data comprising an array of pixels in a current frame of a second stitched video sequence;
subtracting the stitched predictor from a corresponding array of pixels in a corresponding frame of the first stitched video sequence to form a stitched raw residual array of pixels;
encoding the stitched raw residual array of pixels;
decoding the encoded stitched raw residual array of pixels to form a stitched decoded residual array of pixels; and
adding the stitched residual array of pixels to the stitched predictor.

21. The method of claim 20 wherein said step of composing a first stitched video sequence further comprises the steps of:
decoding a plurality of input video bitstreams into a plurality of video sequences, each sequence comprising a plurality of decoded video frames; and
sequentially spatially composing combined image frames from sequential frames of the decoded input video sequences.

22. The method of claim 21 wherein the frames of the decoded video sequences comprise QCIF images and said combined image frames comprise CIF images.

23. The method of claim 21 wherein the frames of the decoded video sequences comprise CIF images and said combined image frames comprise 4CIF images.

24. The method of claim 21 is wherein input video bitstreams conform to one of the ITU-T H.261; ITU-T H.263; or ITU-T H.264 standards.

25. The method of claim 21 further comprising the step of storing prediction information from said plurality of decoded input video bitstreams and using said prediction information to generate said stitched predictor.

26. A method of decoding a pixel block in a frame of a stitched video sequence;
retaining a previous frame in said stitched video sequence;
generating a stitched residual block by entropy decoding, inverse transforming and dequantizing a bitstream containing entropy coded, forward transformed and quantized stitched raw residual block formed by subtracting a first stitched predictor from a frame in an ideal stitched video sequence;
generating a second stitched predictor for the pixel block in the frame to be decoded in the video sequence in substantially the same manner that said first stitched predictor was generated; and
adding the decoded stitched residual block to the stitched predictor.

27. The method of claim 26 wherein said bitstream conforms to one of the ITU-T; H.261; H.263; or H.264 standards.

28. A method of stitching a plurality of input video bitstreams conforming to the ITU-T H.264 video coding standard, the method comprising:
decoding said plurality of input video bitstreams to produce a plurality of pixel-domain pictures;
spatially composing said plurality of pixel-domain pictures to create an ideal stitched video frame;
storing at least one of prediction information and a quantization parameter for at least a portion of the pixel domain pictures produced from said plurality of decoded video bitstreams;
forming a stitched predictor by performing temporal prediction for inter-coded portions of the stitched video frame based on the stored information and a retained reference frame in said sequence of stitched video frames, and performing spatial prediction using stored information on the stitched video frame;
forming a stitched raw residual by subtracting the stitched predictor for a portion of the stitched video frame from a corresponding portion of the ideal stitched video frame;
forward transforming and quantizing the stitched raw residual; and
entropy encoding the forward transformed and quantized stitched raw residual.

29. The method of claim 28 wherein said prediction information comprises one or more of macroblock type, intra luma prediction mode, intra chroma prediction mode, motion vectors and reference picture indices.

30. The method of claim 28 further comprising the steps of:
storing one of a sub-macroblock type, motion vector, and reference picture index, for at least one portion of the pixel domain pictures produced from said plurality of decoded video bitstreams.

31. The method of claim 29 further comprising the steps of:
modifying the stored macroblock type from P_SKIP to P_L0_{—}16×16 for a portion of a pixel domain picture for which the stored motion vector takes any part of the portion of the pixel domain picture into a spatial region in the ideal stitched picture corresponding to a pixel domain picture produced from a bitstream that is different from the bitstream from which the pixel domain picture whose spatial region the portion is situated was produced.

32. The method of claim 29 further comprising the steps of:
computing a coded block pattern that identifies pixel blocks within said portion of said ideal stitched video frame which resulted in non-zero coefficients after forward transforming and quantizing the stitched raw residual;
modifying the stored macroblock type for at least one macroblock for which the macroblock prediction mode is Intra_{—}16×16 in such a way that the modified macroblock type continues to have a macroblock prediction mode of Intra_{—}16×16;
modifying the stored macroblock type for at least one macroblock for which the macroblock prediction mode is Intra_{—}16×16 in such a way that intra 16×16 prediction mode of the modified macroblock type is unchanged; and
modifying the stored macroblock type for at least one macroblock for which the macroblock prediction mode is Intra_{—}16×16 in such a way that the modified macroblock type corresponds to the computed coded_block_pattern.

33. The method of claim 28 further comprising the steps of:
computing a syntax element mb_skip_run for an image slice by computing the number of consecutive macroblocks that have macroblock type equal to P_SKIP;
computing a syntax element mb_qp_delta for a macroblock by subtracting a stored quantization parameter for the spatially preceding macroblock from the said macroblock;
computing a syntax element prev_intra4×4_pred_mode and a syntax element rem_intra4×4_pred_mode for at least one block in a macroblock for which the stored prediction mode is Intra_{—}4×4; and
computing a syntax element mvd_{—}10 for at least one partition in at least one macroblock by subtracting a motion vector predicted from neighboring portions from the stored motion vector.

34. The method of claim 28 further comprising the steps of:
forming a MISSING_IDR_SLICE that is inserted into a first frame of said stitched bitstream, said missing _IDR_SLICE corresponding to a spatial portion in the ideal stitched picture for which no pixel-domain picture was decoded;
forming a MISSING_P_SLICE_WITH_I_MBS that is inserted into a frame of said stitched bitstream, said missing _P_SLICE_WITH_I_MBS corresponding to a spatial portion in the ideal stitched picture for which no pixel-domain picture was decoded;
forming a MISSING_P_SLICE_WITH_P_MBS that is inserted into a frame of said stitched bitstream, said missing_P_SLICE_WITH_P_MBS corresponding to a spatial portion in the ideal stitched picture for which the pixel-domain picture from the temporally prior ideal stitched picture was reused.

35. The method of claim 29 further comprising the steps of modifying the stored reference picture index.

36. The method of claim 29 further comprising the steps of:
constructing a mapping between a frame number of a decoded video bitstream and stitched bitstream;
using the mapping to modify the stored reference picture index that refers to a short-term reference picture in said decoded video bitstream.

37. The method of claim 28 further comprising the steps of determining whether stitching for at least one quadrant in the stitched video frame may be simplified when the corresponding input picture is coded using only I-slices;
generating a picture parameter set for the stitched bitstream that captures the same slice group structure in the said quadrant as that in the said input picture; and
making specific changes to a corresponding slice header part but not to a corresponding slice data part of a NAL unit corresponding to said quadrant in the stitched bitstream.

38. A method of stitching a plurality of input video bitstreams conforming to the ITU-T H.263 video coding standard, the method comprising:
decoding said plurality of video bitstreams to produce a plurality of pixel-domain pictures;
spatially composing said plurality of pixel-domain pictures to create a single ideal stitched video frame;
storing at least one of prediction information, and a quantization parameter for at least one macroblock in said plurality of decoded video bitstreams;
forming a stitched predictor by performing temporal prediction for inter-coded portions of the stitched video frame based on the stored information and a retained reference frame in said sequence of stitched video frames and performing spatial prediction using stored information on the stitched video frame;
forming a stitched raw residual by subtracting the stitched predictor for a portion of the stitched video frame from a corresponding portion of the ideal stitched video frame;
forward transforming and quantizing the stitched raw residual; and
entropy encoding the forward transformed and quantized stitched raw residual to form a stitched bitstream.

39. The method of claim 38 wherein said prediction information comprises macroblock type and motion vectors.

40. The method of claim 39 further comprising the steps of:
computing a differential quantization parameter for at least one macroblock by subtracting the quantization parameter of a temporally preceding macroblock from the quantization parameter of said macroblock and clipping the difference;
modifying the macroblock type from INTRA to INTRA+Q for at least one macroblock for which the computed differential quantization parameter is not equal to 0;
modifying the macroblock type from INTER to INTER+Q for at least one macroblock for which the computed differential quantization parameter is not equal to 0;
modifying the macroblock type from INTRA+Q to INTRA for at least one macroblock for which the computed differential quantization parameter is equal to 0;
modifying the macroblock type from INTER+Q to INTER for at least one macroblock for which the computed differential quantization parameter is equal to 0;
computing a coded block pattern that identifies pixel blocks within said portion of said ideal stitched video frame which resulted in non-zero coefficients after forward transforming and quantizing the stitched raw residual; and
computing a syntax element COD for at least one macroblock based on a computed coded block pattern, a computed differential quantization parameter and a stored motion vector.

41. The method of claim 38 wherein said input video bitstreams use none or one or more of H.263 Annexes D, E, F, I, J, K, R, S, T, and U.

42. The method of claim 38 wherein said stitched video bitstream uses none of the optional H.263 Annexes.

43. The method of claim 38 further comprising the steps of:
forming a MISSING_I_FRAME that is inserted into a first frame of said stitched bitstream, said missing_I_FRAME corresponding to a spatial portion in the ideal stitched picture for which no pixel-domain picture was decoded;
forming a MISSING_GOB_WITH_I_MBS that is inserted into a frame of said stitched bitstream, said missing_GOB_WITH_I_MBS corresponding to a spatial portion in the ideal stitched picture for which no pixel-domain picture was decoded;
forming a MISSING_GOB_WITH_P_MBS that is inserted into a frame of said stitched bitstream, said missing_GOB_WITH_P_MBS corresponding to a spatial portion in the ideal stitched picture for which pixel-domain picture from the temporally prior ideal stitched picture was reused.

44. A partially drift-free method for performing nearly compressed domain video stitching for H.263 video bitstreams, method comprising:
parsing a plurality of individual video bitstreams;
decoding picture, GOB (group of blocks), and MB (macroblock) layer headers in the said individual video bitstreams;
modifying a differential motion vector for at least one macroblock associated with one of said individual video bitstreams;
modifying a COD value from 1 to 0 for at least one macroblock in one of said individual video bitstreams;
modifying a DQUANT value for at least one macrobrock in one of said individual video bitstreams;
modifying a QUANT value for at least one macroblock in one of said video bitstreams;
requantizing and VLC encoding the macroblock for which the QUANT value was modified; and
constructing the stitched bitstream including the modified DQUANT value and the requantized VLC encoded macroblock.

45. The method of claim 44 wherein only the COD values of the macroblocks in any row on either side of a quadrant boundary that are 1 are changed to 0.

46. The method of claim 44 wherein the QUANT value of the macroblocks are modified only if the DQUANT modification exceeds the H.263 standard specified limit of 2 or is below the H.263 standard specified limit of −2.

47. The method of claim 44 further comprising distributing the QUANT modification to macroblocks in any row on either side of a quadrant boundary by using a quality of stitching metric that captures the extent of QUANT modification as well as the number of times requantization and reencoding is needed.

48. A lossless method for performing compressed domain video stitching of a plurality of H.263 video bitstreams encapsulated as RTP packets the method comprising:
extracting a plurality of individual video bitstreams from a current incoming RTP packets from among a plurality of incoming RTP packets;
parsing the individual video bitstreams;
decoding picture, GOB (group of blocks), and MB (macroblock) layer headers in the individual video bitstreams;
modifying a differential motion vector for at least one macroblock in one of said individual video bitstreams;
modifying a DQUANT value for at least one macrobrock in one of said individual video bitstreams;
terminating the current incoming RTP packet and starting a next RTP packet of said plurality of incoming RTP packets the if the absolute value of the DQUANT modification exceeds 2, or if a motion vector points to a location in another quadrant for a macroblock in one of said video bitstreams, and
incorporating an actual MV and QUANT value in the RTP header fields of every RTP packet of the stitched video bitstream.

49. A lossless method of performing video stitching on first, second, third, and fourth individual video sequences encoded according to ITU-T H.263 Annex K where each video frame of said first, second, third, and fourth video sequence comprises a plurality of rectangular slices, the method comprising:
modifying OPPTYPE bits 1-3 in a picture header of a frame in said first video sequence;
modifying an MBA parameter for each slice in a frame from each of said first, second, third, and fourth video sequences such that the modified MBA parameters represent locations in a stitched video frame having four times higher resolution than a frame in said first, second, third and fourth video sequences, such that slices from said first video sequence occupy a first quadrant of said stitched video frame, slices from said second video sequence occupy a second quadrant of said stitched video frame, slices from said third video sequence occupy a third quadrant of said stitched video frame, and slices from said fourth video sequence occupy a fourth quadrant of said stitched video frame; and
arranging the slices from the first, second, third, and fourth video sequences into a stitched bitstream such that the slices from said first video stream alternate with the slices from said second video stream, and the slices from the third video sequences alternate with the slices from the fourth vide sequences, following the slices from the first and second video sequences in a similar alternating manner.

50. A method of stitching frames from a plurality of video sequences comprising:
defining a nominal frame rate fₙₒₘ;
defining a maximum frame rate fₘₐₓ;
decoding received frames in said plurality of video sequences;
stitching together a set of decoded frames one from each of said plurality of video sequences to form a composite stitched video frame;
determining when bitstream data corresponding to two complete frames belonging to one of the said plurality of video sequences are available for decoding;
defining a time tₜₐᵤ as the time elapsed between the time a previous composite frame was stitched and the time that bitstream data corresponding to two complete frames belonging to one of the said plurality of video sequences are available for decoding;
invoking the stitching operation at a time tₛ, where tₛ is equal to the greater of 1/fₘₐₓ and the smaller of 1/fₙₒₘ and tₜₐᵤ.

51. A method of concealing macroblock lost in the transmission of an H.264 encoded video stream comprising:
determining whether the macroblock was in an inter-coded slice;
if the slice was an inter-coded slice, estimating the motion vector and corresponding reference picture of the lost macroblock from received macroblocks neighboring the lost macroblock;
performing motion compensation using the estimated motion vector and corresponding reference picture to obtain pixel information for the lost macroblock.

52. A method of concealing a macroblock lost in transmission of an H.264 encoded video stream, the method comprising:
determining whether the macroblock was in an intra-coded slice or an IDR slice;
if the slice was an intra-coded slice or IDR slice, initiating a videofastupdatepicture command through an H.241 signaling mechanism.

53. A method of concealing the loss of bitstream data corresponding to one or more frames in the transmission of an H.264 encoded video stream comprising:
determining a number of frames lost in transmission;
copying pixel information from a temporally previous frame to re-create a lost frame;
marking said lost frame as a short-term reference picture through a sliding window process specified in the H.264 standard.

54. A method of decoding an ITU-T H.264 bitstream comprising:
initiating a videofastupdatepicture command via an H.241 signalling method when any one of the following conditions is detected;
a loss of sequence parameter set is detected in the bitstream;
a loss of picture parameter set is detected in the bitstream;
a loss of an IDR-slice is detected in the bitstream;
a loss of an I-slice is detected in the bitstream; or
gaps in frame_num are allowed in the bitstream and packet loss is detected in the bitstream;

55. A method of concealing a macroblock lost in the transmission of an H.263 encoded video stream comprising:
determining whether the macroblock was a P-macroblock;
if the macroblock was a P-macroblock, estimating the motion vector of the lost macroblock from received macroblocks neighboring the lost macroblock;
performing motion compensation using the estimated motion vector to obtain pixel information for the lost macroblock.

56. A method of concealing a macroblock lost in the transmission of an H.263 encoded video stream comprising:
determining whether the macroblock was an I-macroblock in an I-frame;
if the macroblock was an I-macroblock in an I-frame, initiating a videofastupdatepicture command through an H.245 signaling mechanism.
